(19) United States
(12) Patent Application Publication
(10) Pub. No.: US 2025/0307703 A1
(43) Pub. Date: Oct. 2, 2025

(54) LEARNING DEVICE, DETERMINATION DEVICE, LEARNING METHOD, AND RECORDING MEDIUM

(71) Applicant: NEC Corporation, Minato-ku, Tokyo (JP)

(72) Inventors: Kazuya KAKIZAKI, Tokyo (JP); Jun FURUKAWA, Tokyo (JP); Toshinori ARAKI, Tokyo (JP)

(73) Assignee: NEC Corporation, Minato-ku, Tokyo (JP)

(21) Appl. No.: 18/863,012

(22) PCT Filed: May 31, 2022
(86) PCT No.: PCT/JP2022/022235

§ 371 Date: Nov. 5, 2024

(51) Int. Cl. G06N 20/00

(52) U.S. Cl. CPC G06N 20/00

(57) ABSTRACT

A learning device determines, for a plurality of parameters of a machine learning model having the plurality of parameters, mask information representing a distinction between a shared parameter provided for common use by a plurality of machine learning models, and a non-shared parameter that is provided individually to each machine learning model. The learning device calculates a value of a loss function with respect to training data. The loss function is based on the plurality of machine learning models to which the shared parameter, the non-shared parameter, and a parameter value indicated by the mask information have been applied. The learning device updates a value of the shared parameter and a value of the non-shared parameter by using the value of the loss function.

### TECHNICAL FIELD

The present invention relates to a learning device, a determination device, a learning method, and a recording medium.

### BACKGROUND ART

A determination device can be configured to use a plurality of machine learning models, such as a determination device based on ensemble learning.

For example, in Patent Document 1, the use of neural networks (NN) in ensemble learning for face recognition and the like is disclosed.

Furthermore, Non-Patent Document 1 describes ensemble-based robust training (ERT). In ensemble-based robust training, ensemble learning is performed such that the obtained determination device is less susceptible to being deceived by adversarial examples (AX). The fact that a determination device is less likely to be deceived by adversarial examples means that the determination device is less likely to make an incorrect determination with respect to an input of an adversarial example.

### PRIOR ART DOCUMENTS

### Patent Document

Patent Document 1: International Publication No. WO2017/126482

### Non-Patent Document

Non-Patent Document 1: Huanrui Yang, and 8 others, “DVERGE: Diversifying Vulnerabilities for Enhanced Robust Generation of Ensemble”, NeurIPS2020, 2020

### SUMMARY OF THE INVENTION

### Problems to be Solved by the Invention

It is preferable that the number of parameter values to be stored by a determination device that uses a plurality of machine learning models can be made relatively small.

An example object of the present invention is to provide a learning device, a determination device, a learning method, and a recording medium that are capable of solving the problem described above.

### Means for Solving the Problem

According to a first example aspect of the present invention, a learning device includes: a mask initialization means that determines, for a plurality of parameters of a machine learning model having the plurality of parameters, mask information representing a distinction between a shared parameter provided for common use by a plurality of machine learning models, and a non-shared parameter that is provided individually to each machine learning model; a loss function calculation means that calculates a value of a loss function with respect to training data, the loss function being based on the plurality of machine learning models to which the shared parameter, the non-shared parameter, and a parameter value indicated by the mask information have been applied; and a parameter updating means that updates a value of the shared parameter and a value of the non-shared parameter by using the value of the loss function.

According to a second example aspect of the present invention, a learning method is executed by a computer, and includes the steps of: determining, for a plurality of parameters of a machine learning model having the plurality of parameters, mask information representing a distinction between a shared parameter provided for common use by a plurality of machine learning models, and a non-shared parameter that is provided individually to each machine learning model; calculating a value of a loss function with respect to training data, the loss function being based on the plurality of machine learning models to which the shared parameter, the non-shared parameter, and a parameter value indicated by the mask information have been applied; and updating a value of the shared parameter and a value of the non-shared parameter by using the value of the loss function.

According to a third example aspect of the present invention, a recording medium records a program that causes a computer to execute the steps of determining, for a plurality of parameters of a machine learning model having the plurality of parameters, mask information representing a distinction between a shared parameter provided for common use by a plurality of machine learning models, and a non-shared parameter that is provided individually to each machine learning model; calculating a value of a loss function with respect to training data, the loss function being based on the plurality of machine learning models to which the shared parameter, the non-shared parameter, and a parameter value indicated by the mask information have been applied; and updating a value of the shared parameter and a value of the non-shared parameter by using the value of the loss function.

### Effect of Invention

According to the learning device, the determination device, the learning method, and the recording medium described above, it is possible for the number of parameter values to be stored by a determination device that uses a plurality of machine learning models, to be made relatively small.

### BRIEF DESCRIPTION OF THE DRAWINGS

FIG. 1 is a diagram showing an example of a plurality of neural networks in which all of the parameters are configured as non-shared parameters.

FIG. 2 is a diagram showing an example of a plurality of neural networks including shared parameters.

FIG. 3 is a schematic block diagram showing an example of a functional configuration of a learning device according to a first example embodiment.

FIG. 4 is a flowchart showing an example of the processing procedure performed by the learning device according to the first example embodiment.

FIG. 5 is a flowchart showing an example of the processing procedure of a loss function calculation performed by the learning device according to the first example embodiment.

FIG. 6 is a schematic block diagram showing an example of a functional configuration of a learning device according to a second example embodiment and a third example embodiment.

FIG. 7 is a flowchart showing an example of the processing procedure performed by the learning device according to the second example embodiment.

FIG. 8 is a flowchart showing an example of the processing procedure performed by the learning device according to the third example embodiment.

FIG. 9 is a flowchart showing an example of the processing procedure performed by the learning device according to the third example embodiment.

FIG. 10 is a schematic block diagram showing an example of a functional configuration of a determination device according to a fourth example embodiment.

FIG. 11 is a schematic block diagram showing an example of a functional configuration of a learning device according to a fifth example embodiment.

FIG. 12 is a flowchart showing an example of the processing procedure performed in a learning method according to a sixth example embodiment.

FIG. 13 is a schematic block diagram showing a configuration of a computer according to at least one example embodiment.

### EXAMPLE EMBODIMENTS

Hereunder, example embodiments of the present embodiment will be described. However, the following example embodiments do not limit the invention according to the claims. Furthermore, all combinations of features described in the example embodiments may not be essential to the solution means of the invention.

First, an example of a neural network including shared parameters in an example embodiment will be compared with an example of a neural network in which all of the parameters are configured as non-shared parameters.

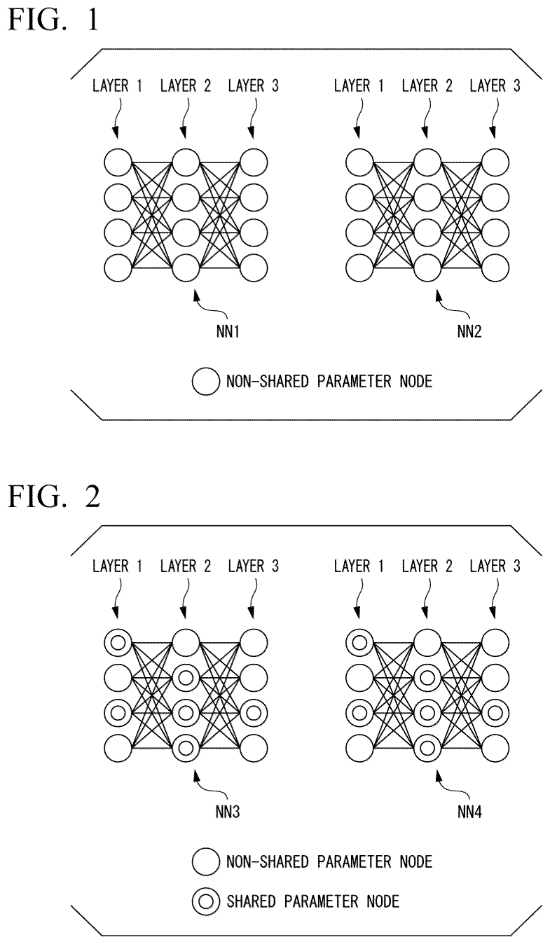

FIG. 1 is a diagram showing an example of a plurality of neural networks in which all of the parameters are configured as non-shared parameters.

NN1 and NN2 shown in FIG. 1 are neural networks having the same structure. Specifically, NN1 and NN2 are fully connected neural networks each having a layer 1, a layer 2, and a layer 3, with each layer having four nodes. Each node is configured using a neuron model (artificial neuron).

In both NN1 and NN2, all of the parameters are provided individually to each neural network. FIG. 1 shows an example in which it is determined, for each node, whether or not parameters are provided individually to each neural network or provided for common use by a plurality of neural networks, and the parameters are provided individually to each neural network for all of the nodes.

The parameters that are provided individually to each neural network are also referred to as non-shared parameters. The nodes in which it is determined that the parameters are provided individually to each neural network are also referred to as non-shared parameter nodes. In FIG. 1, the non-shared parameter nodes are represented by circles (◯).

On the other hand, the parameters that are provided for common use by a plurality of neural networks are referred to as shared parameters. The nodes in which it is determined that the parameters are provided for common use by a plurality of neural networks are also referred to as shared parameter nodes.

The parameters of a neural network are provided according to the type of neural network. For example, in the case of a perceptron, the weighting coefficient provided to each connection between nodes, and the bias provided to each node for calculating the node output correspond to examples of parameters. Furthermore, even in a generalized neural network in which an activation function is not limited to a step function of a perceptron, the weighting coefficient provided to each connection between nodes, and the bias provided to each node for calculating the node output correspond to examples of parameters.

In addition, in a spiking neural network (SSN), the weighting coefficient provided to each connection between nodes, and the firing threshold provided to each node correspond to examples of parameters.

If it is determined, for each node, whether the parameters are provided individually to each neural network or provided for common use by a plurality of neural networks, the parameters provided to the connections between nodes can be treated as belonging to the node that receives the input of the information transmitted by the connection. Specifically, the parameters provided to connections in which a non-shared parameter node is serving as the input node may be non-shared parameters. Furthermore, the parameters provided to connections in which a shared parameter node is serving as the input node may be shared parameters.

A plurality of neural networks such as NN1 and NN2 can be used, for example, in ensemble learning. In ensemble learning, a system including a plurality of machine learning models is trained. Such a system determines the output of the system based on the outputs of a plurality of machine learning models, such as by taking a majority vote of the outputs of the plurality of machine learning models.

Hereunder, a system that includes a plurality of machine learning models, and determines the output of the system based on the outputs of the plurality of machine learning models will be referred to as an ensemble system. Furthermore, a machine learning model included in the ensemble system will be referred to as a “machine learning model in the ensemble”. For example, a neural network included in the ensemble system will be referred to as a “neural network in the ensemble”.

FIG. 2 is a diagram showing an example of a plurality of neural networks including shared parameters.

NN3 and NN4 shown in FIG. 2 are neural networks having the same structure. Specifically, NN3 and NN4 are fully connected neural networks each having a layer 1, a layer 2, and a layer 3, with each layer having four nodes. Each node is configured using a neuron model.

In NN1 and NN2 of FIG. 1, all of the parameters are non-shared parameters. In contrast, NN3 and NN4 of FIG. 2 include shared parameters. In FIG. 2, the non-shared parameter nodes are represented by circles (◯), and the shared parameter nodes are represented by double circles (⊚).

Because NN3 and NN4 have the same structure, parameters in the same positions in the structure of the neural networks of NN3 and NN4 can be associated, and the parameters in the same positions can be provided for common use. In the example of FIG. 2, nodes in the same positions in the structure of the neural networks of NN3 and NN4 are shared parameter nodes. As a result, parameters in the same positions in the structure of the neural networks of NN3 and NN4 are shared parameters.

In this way, parameters in the same positions in the structure of the neural networks can be associated between a plurality of neural networks having the same structure, and parameters in the same positions can be provided for common use. Providing a parameter for common use by a plurality of neural networks is also referred to as a plurality of neural networks sharing a parameter.

As a result of a plurality of neural networks sharing only some of the parameters, it is possible to suppress the memory area required to configure the plurality of neural networks, while also enabling the plurality of neural networks to be configured as different neural networks.

Here, in a case where two neural networks have the same structure, and the values of the parameters in the same positions in the structure of the neural networks are all the same, the two neural networks are referred to as being the same. On the other hand, in a case where the structures of two neural networks are different, the two neural networks are referred to as being different. Similarly, even if two neural networks have the same structure, in a case where the values of at least one pair of parameters among the parameters in the same positions in the structure of the neural networks are different, the two neural networks are referred to as being different.

Different neural networks may output different values in response to the same input data. As a result of configuring a plurality of neural networks as neural networks that are different from each other, it is possible to configure a system that determines the output of the system based on the outputs of the plurality of neural networks. For example, a majority vote model that takes a majority vote of the outputs of the plurality of neural networks may be configured as a system.

For example, in a case where a plurality of neural networks sharing only some of the parameters are used in ensemble-based robust training, compared to a case where neural networks are used in which all of the parameters are provided individually to each neural network, the memory area required to configure the plurality of neural networks can be reduced, while also enabling the number of neural networks in the ensemble to be increased, which is expected to improve the robustness.

Here, one of the critical issues regarding the safety of machine learning models is the problem of adversarial examples (EX]). Adversarial examples are input data that are intentionally generated with small perturbations that lead a machine learning model to make an incorrect determination. There is a need for methods to make machine learning models, such as neural networks, robust to adversarial examples.

Ensemble-based robust training (ERT) is one method for making a machine learning model robust to adversarial examples. Ensemble learning is a learning method for improving the predictive capabilities with respect to unknown data, by taking a majority vote or the like using a plurality of neural networks that have been individually trained.

Ensemble-based robust training is a learning method that aims to realize robust predictions as a system using a plurality of neural networks by training the neural networks in the ensemble to be less susceptible to being simultaneously deceived by adversarial examples (less susceptible to making an incorrect determination). In ensemble-based robust training, it is expected that the robustness will improve by increasing the number of neural networks in the ensemble.

In a case where neural networks are used in ensemble-based robust training in which all of the parameters are configured as non-shared parameters, the number of parameters increases in proportion to the number of neural networks. In this case, if the number of neural networks is large, the storage capacity required to store the parameter values will become large, which may lead to processing delays. Furthermore, in this case, due to limitations in the memory capacity that can be used to store the parameter values, it may not be possible to sufficiently increase the number of neural networks and ensure sufficient robustness.

In contrast, in a case where neural networks are used in which only some of the parameters are configured as shared parameters in the ensemble-based robust training, by sharing the parameters, the number of parameters can be reduced compared to a case where neural networks are used in which all of the parameters are configured as non-shared parameters. This is expected to result in relatively fast processing speeds. Moreover, in this case, the number of neural networks can be made relatively large. In this respect, it is expected that the robustness will improve.

In the description above, an example has been described in which a neural network is used as the machine learning model. However, the machine learning model is not limited to this. Various machine learning models can be used that can update parameters using a learning technique such as error backpropagation, and which have a plurality of parameters and allow the parameters to be shared in ensemble learning. Examples of such machine learning models include, in addition to neural networks, support vector machines (SVM) and random forests.

In the following, an example will be described in which a neural network is used as the machine learning model. However, the machine learning model is not limited to this. Various machine learning models can be used that can update parameters using a learning technique such as error backpropagation, and which have a plurality of parameters and allow the parameters to be shared in ensemble learning.

In addition, in the description above, an example has been described in which ensemble learning is performed using a plurality of machine learning models. However, a system using a plurality of machine learning models is not limited to a system that determines the system output by taking a majority vote of the outputs of a plurality of machine learning models in the manner of ensemble learning. For example, a system using a plurality of machine learning models may determine the system output by taking a majority vote after applying a weight to the outputs of the plurality of machine learning models.

Furthermore, a system using a plurality of machine learning models may, in addition to, or instead of, determining the system output using the outputs of the plurality of machine learning models, calculate an index value relating to the outputs of the plurality of machine learning models, such as the variance or reliability of the plurality of machine learning models.

Also, an example in which error backpropagation is used as the machine learning technique will be described. However, the machine learning techniques that can be applied are not limited to this.

In the following, a system using a plurality of machine learning models is not limited to a system that determines the system output by taking a majority vote of the outputs of the plurality of machine learning models. For example, a system using a plurality of machine learning models may determine the system output by taking a majority vote after applying a weight to the outputs of the plurality of machine learning models.

Furthermore, a system using a plurality of machine learning models may, in addition to, or instead of, determining the system output using the outputs of the plurality of machine learning models, calculate an index value relating to the outputs of the plurality of machine learning models, such as the variance or reliability of the plurality of machine learning models.

In the following, the machine learning techniques that can be applied are not limited to error backpropagation.

In the following, as in the description above, the structure of each neural network in the ensemble is assumed to be the same, and the positions of the shared parameters in each neural network are assumed to be the same in terms of the position in the structure of the neural network.

### First Example Embodiment

In the ensemble-based robust training (ERT) according to a first example embodiment, the positions of the shared parameters of the neural networks (NN) in the ensemble are randomly determined, and the parameters of the neural networks are trained by solving the optimization problem in expression (7) described below.

First, if the number of neural networks in the ensemble is K, a shared vector and non-shared vectors, which have the parameters of the neural networks as elements, can be expressed as in expression (1).

$$\begin{matrix}[ Expression 1 ] & \\ {θ}^{s} , {θ}_{1}^{ns} , … , {θ}_{K}^{n s} ∈ {R}^{\vert θ \vert} & ( 1 )\end{matrix}$$

θ is a vector that represents the parameters of a single neural network in the ensemble. As described above, the neural networks in the ensemble have the same structure. Therefore, the neural networks have the same number of parameters. |θ| represents the number of parameters in a single neural network in the ensemble.

R^{|θ|} represents a set of |θ|-dimensional vectors (of size |θ|) having |θ| real numbers as elements. The parameter vectors of the neural networks are the elements of R^{|θ|}. θ^{s} is a shared parameter vector that holds the parameters shared between the neural networks. s represents shared. θⱼ^{ns} (1≤j≤K) are non-shared parameter vectors that hold the parameters of the jth neural network that are not shared between the neural networks. ns represents non-shared. Hereunder, the jth neural network in the ensemble is also simply referred to as the jth neural network. In this case, 1≤j≤K.

As shown in expression (1), the shared parameter vector and the non-shared parameter vectors can each be made vectors having the same number of real number elements as parameters of a single neural network in the ensemble.

At the time of operation using a learning result, only some of the elements indicated by a mask are accessed (written and read) in each of the shared parameter vector and the non-shared parameter vectors. Elements that are not accessed do not need to be allocated storage capacity, such as memory. Therefore, in a determination device used at the time of operation that is configured using trained neural networks, the storage capacity required to store the parameter values can be reduced by sharing the parameters.

A shared mask vector M for representing the shared positions of the shared parameter vector can be represented as in expression (2).

$$\begin{matrix}[ Expression 2 ] & \\ M ∈ {\{ 0 , 1 \}}^{\vert θ \vert} & ( 2 )\end{matrix}$$

The shared mask vector M is a |θ|-dimensional binary vector, and the value of each element is 0 or 1. An element value of 1 represents a shared position. A shared position represents the position of an element in the shared parameter vector that is associated with a shared parameter. There is a one-to-one correspondence between the elements of the shared parameter vector and the parameters of a single neural network in the ensemble. Therefore, it can be said that the shared mask vector M indicates the positions of the shared parameters in the structure of the neural networks.

The shared mask vector M is an example of mask information.

A non-shared mask vector \hat{ }M for representing the non-shared positions of the non-shared parameter vectors can be represented as in expression (3).

$$\begin{matrix}[ Expression 3 ] & \\ \hat{M} ∈ {\{ 0 , 1 \}}^{\vert θ \vert} & ( 3 )\end{matrix}$$

The non-shared mask vector \hat{ }M is also a |θ|-dimensional binary vector, and the value of each element is 0 or 1. An element value of 1 represents a non-shared position. Anon-shared position represents the position of an element in the non-shared parameter vector that is associated with a non-shared parameter. There is a one-to-one correspondence between the elements of a non-shared parameter vector and the parameters of a single neural network in the ensemble. Therefore, it can be said that the non-shared mask vector \hat{ }M indicates the positions of the non-shared parameters in the structure of the neural networks.

The non-shared mask vector \hat{ }M is a vector that is obtained by inverting the 0 and 1 values of the shared mask vector M.

Extraction of the shared parameters from the shared parameter vector can be represented as in expression (4).

$$\begin{matrix}[ Expression 4 ] & \\ {θ}^{s} ○ M & ( 4 )\end{matrix}$$

In the expression, the white circle (◯) represents the Hadamard product, which calculates the element-wise product of vectors. That is to say, if z=x◯y, then zᵢ=xᵢ×yᵢ (1≤i≤|θ|).

In the vector “θ^{s}◯M”, which is the computation result from expression (4), the elements at the shared positions represent the values of the shared parameters, and the values of the elements at the non-shared positions are 0.

Extraction of the non-shared vector of the jth neural network from the non-shared parameter vector can be expressed as in expression (5).

$$\begin{matrix}[ Expression 5 ] & \\ {θ}_{j}^{ns} ○ \hat{M} & ( 5 )\end{matrix}$$

As described above, ◯ represents the Hadamard product.

In the vector “θ^{s}◯M”, which is the computation result from expression (5), the elements at the non-shared positions represent the values of the non-shared parameters, and the values of the elements at the shared positions are 0.

The parameter vector θⱼ of the jth neural network can be expressed as in expression (6).

$$\begin{matrix}[ Expression 6 ] & \\ {θ}_{j} = {θ}^{s} ○ M + {θ}_{j}^{ns} ○ \hat{M} & ( 6 )\end{matrix}$$

The parameter vector θⱼ is a vector representing the values of the parameters of the jth neural network. The parameter vector θⱼ has elements of the shared vector θ^{s} at the shared positions represented by the shared mask vector M, and has the elements of the non-shared parameter vector θⱼ^{ns} of the jth neural network at the non-shared positions represented by the non-shared mask vector \hat{ }M.

Next, the optimization problem in expression (7) will be described.

$$\begin{matrix}[ Expression 7 ] & \\ {arg min}_{{θ}^{s} , {θ}_{1}^{ns} , … , {θ}_{K}^{ns}} {E}_{( {x}_{s} , {y}_{s} ) , ( {x}_{t} , {y}_{t} ) , l} {\sum }_{j \neq i} {CE}_{{f}_{{θ}_{i}}} ( {x}_{s} + {Δ}_{{f}_{{θ}_{j}}} ( {x}_{s} , {x}_{t} , l ) , {y}_{s} ) & ( 7 )\end{matrix}$$

In expression (7), “xₛ” represents input data to the neural network, such as image data, and “ys” represents the correct class label (class value) of xₛ. Similarly, “xₜ” represents input data to the neural network, and “yt” represents the correct class label of xₜ. Here, it is assumed that “xₛ” and “xₜ” represent input data belonging to different classes. That is to say, yₛ≠yₜ. “Δf_{θj}(xₛ, xₜ, l)” represents an adversarial perturbation (noise), and is calculated by the expression (8) below.

$$\begin{matrix}[ Expression 8 ] & \\ {Δ}_{{f}_{{θ}_{j}}} ( {x}_{s} , {x}_{t} , l ) = {arg min}_{δ} {\vert {f}_{{θ}_{j}}^{l} ( {x}_{s} + δ ) - {f}_{{θ}_{j}}^{l} ( {x}_{t} ) \vert}_{2}^{2} such that {\vert δ \vert}_{∞} \leq ϵ & ( 8 )\end{matrix}$$

In expression (8), “l” represents one selected layer of a neural network.

“δ” represents the adversarial perturbation (noise). “|δ|_{∞}≤ε” indicates that the magnitude of δ in the ∞ norm is equal to or less than a given ε. “xₛ+δ” represents input data obtained by adding the adversarial perturbation δ to xₛ.

“f^{l}_{θj}(xₛ+δ)” represents the output (vector) of the lth layer if xₛ+δ is input to the jth neural network using the parameter vector θⱼ.

“f^{l}_{θj}(xₜ)” represents the output (vector) of the lth layer if xₜ is input to the jth neural network using the parameter vector θⱼ.

“|⋅|”²₂″ represents the 2-norm, and “|f^{l}_{θj}(xₛ+δ)−f^{l}_{θj}(xₜ)|²₂” represents the distance between the outputs.

“argmin_{δ} d(δ)” represents calculating a value of a that minimizes d(δ).

Therefore, “Δf_{θj}(xₛ, xₜ, l)” in expression (8) represents, in terms of the output of the lth layer of the jth neural network, a noise δ that, among noise values δ having a magnitude of ε or less, brings xₜ and the output closest to each other if the noise δ is added to xₛ. That is to say, in terms of the output of the lth layer of the jth neural network, the noise δ is the minimum noise that causes xₛ to be incorrectly determined as xₜ.

Returning to expression (7), “xₛ+Δf_{θj}(xₛ, xₜ, l)” represents the input data obtained by adding the adversarial perturbation Δf_{θj}(xₛ, xₜ, l) obtained in expression (8) to xₛ.

“CEf_{θi}(x, y)” is a cross entropy loss function, which is a function that, given input data x and a class label y, outputs a smaller value as the ith neural network using the parameter vector θᵢ more correctly classifies x as y. Therefore, “CEf_{θi}(xₛ+Δf_{θj}(xₛ, xₜ, l), yₛ)” is a function that, even if an adversarial perturbation is added to xₛ so as to cause the lth layer of the jth neural network using the parameter vector θⱼ to make an incorrect determination, outputs a relatively small value in a case where the ith neural network using the parameter vector θᵢ correctly makes the determination yₛ.

“Σ_{j≠i}CEf_{θi}(⋅,⋅)” represents calculating the cross entropy of all neural networks that are different from the jth neural network, and then calculating the total sum.

“E_{(xs,ys),(xt,yt),l}Σ_{j≠i}CEf_{θi}(⋅, )” represents taking the expected value of the total sum of the cross entropies with respect to (xₛ, yₛ), (xₜ, yₜ), and l.

“argmin_{θ^{s}, θ₁^{ns}, . . . , θ_{K}^{ns}}E_{(xs,ys),(xt,yt),l}Σ_{j≠i}CEf_{θi}(⋅, )” represents calculating the parameter vectors θ^{s}, θ₁^{ns}, . . . , θ_{K}^{ns} of each neural network that minimize the expected value of the total sum of the cross entropies mentioned above.

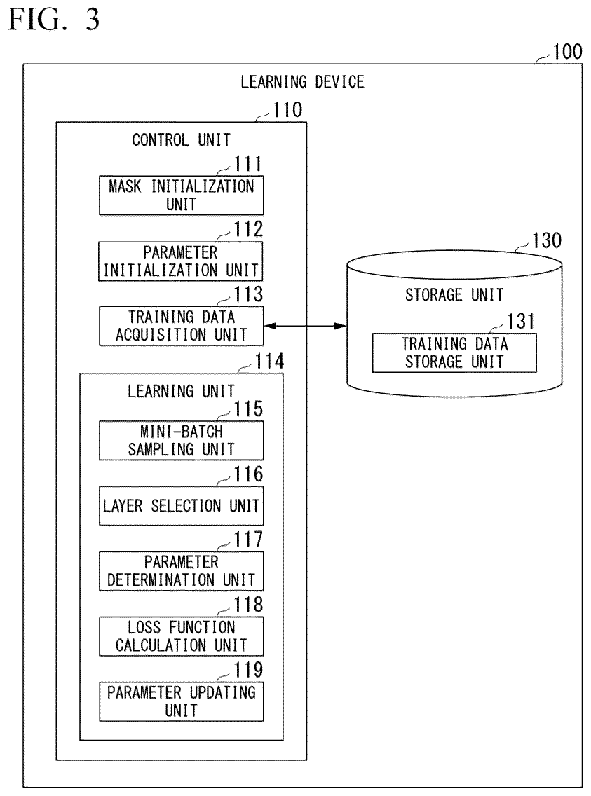

FIG. 3 is a schematic block diagram showing an example of a functional configuration of a learning device 100 according to the first example embodiment. The learning device 100 includes a control unit 110 and a storage unit 130. The control unit 110 includes a mask initialization unit 111, a parameter initialization unit 112, a training data acquisition unit 113, and a learning unit 114. The learning unit 114 includes a mini-batch sampling unit 115, a layer selection unit 116, a parameter determination unit 117, a loss function calculation unit 118, and a parameter updating unit 119. The storage unit 130 includes a training data storage unit 131. The learning device 100 may include other units. Furthermore, the storage unit 130 may be provided outside the learning device 100.

In the ensemble-based robust training (ERT) according to the first example embodiment, the positions of the shared parameters of the neural networks (NN) in the ensemble are randomly determined, and the parameters of the neural networks are learned. The number of neural networks in the ensemble is K.

The mask initialization unit 111 initializes the shared mask vector M and the non-shared mask vector \hat{ }M. The mask initialization unit 111 corresponds to an example of a mask initialization means. The initialization of the shared mask vector M and the non-shared mask vector \hat{ }M performed by the mask initialization unit 111 can be interpreted as processing that randomly selects the shared parameters among the parameters of a single neural network.

As mentioned above, the shared mask vector M and the non-shared mask vector \hat{ }M can be expressed as in expression (9).

$$\begin{matrix}[ Expression 9 ] & \\ M ∈ {\{ 0 , 1 \}}^{\vert θ \vert} , \hat{M} ∈ {\{ 0 , 1 \}}^{\vert θ \vert} & ( 9 )\end{matrix}$$

Specifically, the mask initialization unit 111 sets a proportion p, and randomly initializes the shared mask vector M such that p×|θ| elements are set to 1. Furthermore, the mask initialization unit 111 initializes, as the non-shared mask vector \hat{ }M, a vector in which the 0 or 1 of each element of the mask vector M has been inverted. p represents the proportion of shared parameters of the neural networks in the ensemble. The value of p may be determined in advance according to the usable storage capacity.

Alternatively, the initial values of the shared mask vector M may be determined in advance, and the mask initialization unit 111 may store the initial values of the shared mask vector M in advance.

The parameter initialization unit 112 initializes the shared parameter vector θₛ and each of the non-shared parameter vectors θ₁^{ns}, . . . , θ_{K}^{ns}. As mentioned above, the shared parameters and the non-shared parameters can be expressed as in expression (10).

$$\begin{matrix}[ Expression 10 ] & \\ {θ}^{s} , {θ}_{1}^{ns} , … , {θ}_{K}^{ns} ∈ {R}^{\vert θ \vert} & ( 10 )\end{matrix}$$

For example, the parameter initialization unit 112 randomly initializes the parameter values by assigning random numbers to each element of the parameter vectors. Alternatively, the initial values of the parameters may be determined in advance, and the parameter initialization unit 112 may store the initial values of the parameters as the initial values of the elements of the parameter vectors in advance.

The training data storage unit 131 stores (a set of) training data Xₜᵣ used to train the neural networks.

The training data Xₜᵣ can be expressed as in expression (11).

$$\begin{matrix}[ Expression 11 ] & \\ {X}_{tr} = {\{ {( {x}_{s} , {y}_{s} , {x}_{t} , {y}_{t} )}_{i} \}}_{i = 1}^{\vert {X}_{tr} \vert} & ( 11 )\end{matrix}$$

“xₛ” represents input data to the neural network, such as image data, and “ys” represents the correct class label (class value) of xₛ. Similarly, “xₜ” represents input data to the neural network, and “yₜ” represents the correct class label of xₜ. Here, it is assumed that “xₛ” and “xₜ” represent input data belonging to different classes. That is to say, yₛ≠yₜ.

The training data acquisition unit 113 acquires the training data Xₜᵣ that is stored in the training data storage unit 131.

The learning unit 114 uses the training data Xₜᵣ to update and train the parameter vectors of the neural networks in the ensemble using iterative error backpropagation.

The mini-batch sampling unit 115 samples, from the training data Xₜᵣ, a mini-batch B used in a single learning cycle. Specifically, the mini-batch sampling unit 115 randomly samples a subset from the training data Xₜᵣ to generate the mini-batch B.

The layer selection unit 116 selects one layer l of the neural network to be used to generate the adversarial perturbation Δf_{θj}(xₛ, xₜ, l).

The parameter determination unit 117 determines the parameter vector with respect to each neural network. The parameter determination unit 117 corresponds to an example of a parameter determination means.

As mentioned above, the parameter vector θⱼ of the jth neural network can be expressed as in expression (12).

$$\begin{matrix}[ Expression 12 ] & \\ {θ}_{j} = {θ}^{s} ○ M + {θ}_{j}^{ns} ○ \hat{M} & ( 12 )\end{matrix}$$

Specifically, the parameter determination unit 117 uses the shared mask vector M, the non-shared mask vector \hat{ }M, the shared parameter vector θ^{s}, and the non-shared parameter vectors θⱼ^{ns} (1≤j≤K) to determine (calculate) the parameter vector θⱼ (1≤j≤K) of each neural network. θ^{s} and θⱼ^{ns} (1≤j≤K) are vectors that have been initialized or updated.

The processing in which the parameter determination unit 117 determines the parameter vector θⱼ can be interpreted as processing that configures the jth neural network.

Specifically, a model template for common use is provided with respect to the K neural networks having the same structure. The model template is a template in which the parameters of a neural network are represented by a parameter vector, and a neural network is configured by inputting values to the parameter vector. The jth neural network is configured by applying the parameter vector θⱼ that is determined by the parameter determination unit 117 to the model template.

The loss function calculation unit 118 propagates information by inputting the training data of the mini-batch B={(xₛ, yₛ, xₜ, yₜ)} to each jth neural network (1≤j≤K), and calculates the loss function Loss in expression (13).

$$\begin{matrix}[ Expression 13 ] & \\ Loss = \frac{1}{\vert B \vert} {\sum }_{( {x}_{s} , {y}_{s} , {x}_{t} , {y}_{t} ) ∈ B} {\sum }_{j \neq i} {CE}_{{f}_{{θ}_{i}}} ( {x}_{s} + {Δ}_{{f}_{{θ}_{j}}} ( {x}_{s} , {x}_{t} , l ) , {y}_{s} ) & ( 13 )\end{matrix}$$

In expression (13), “Δf_{θj}(xₛ, xₜ, l)” is the adversarial perturbation shown in expression (8). “l” represents the layer selected by the layer selection unit 116. The adversarial perturbation is, in terms of the output of the lth layer of the jth neural network, the minimum noise that causes xₛ to be incorrectly determined as xₜ.

“xₛ+Δf_{θj}(xₛ, xₜ, l)” represents the input data obtained by adding the adversarial perturbation Δf_{θj}(xₛ, xₜ, l) to xₛ.

“CEf_{θi}(x, y)” is a cross entropy loss function, which is a function that, given input data x and a class label y, outputs a smaller value as the ith neural network using the parameter vector θᵢ more correctly classifies x as y. Therefore, “CEf_{θi}(xₛ+Δf_{θj}(xₛ, xₜ, l), yₛ)” is a function that, even if an adversarial perturbation is added to xₛ so as to cause the lth layer of the jth neural network using the parameter vector θⱼ to make an incorrect determination, outputs a smaller value as the ith neural network using the parameter vector θᵢ more correctly makes the determination yₛ.

“Σ_{j≠i}CEf_{θi}(xₛ+Δf_{θj}(xₛ, xₜ, l), yₛ)” represents calculating the cross entropy of all neural networks that are different from the jth neural network, and then calculating the total sum.

“1/|B|×Σ_{(xs,ys,xt,yt)∈B}Σ_{j≠i}CEf_{θi}(xₛ+Δf_{θj}(xₛ, xₜ, l), yₛ)” represents taking the expected value (average value) of the total sum of cross entropies for all elements (xₛ, yₛ, xₜ, yₜ) in the mini-batch B.

The loss function calculation unit 118 corresponds to an example of a loss function calculation means.

The parameter updating unit 119 updates parameters by backpropagating error information by error backpropagation. The parameter updating unit 119 corresponds to an example of a parameter updating means.

Specifically, the parameter updating unit 119 calculates a partial derivative of the loss function Loss shown in expression (14), and updates θ^{s}.

$$\begin{matrix}[ Expression 14 ] & \\ \frac{\partial }{\partial {θ}^{s}} Loss & ( 14 )\end{matrix}$$

Expression (14) represents calculating ∂Loss/∂(θ^{s})ᵢ with respect to the elements (θ^{s})ᵢ (1≤i≤|θ|) of θ^{s}. The parameter updating unit 119, for example, with a predetermined learning coefficient α (>0), updates (θ^{s}); to (θs)ᵢ−α×∂Loss/∂(θ^{s})ᵢ.

Furthermore, the parameter updating unit 119 calculates a partial derivative of the loss function Loss shown in expression (15), and updates θ^{ns} (j=1, . . . , K).

$$\begin{matrix}[ Expression 15 ] & \\ \frac{\partial }{\partial {θ}_{j}^{ns}} Loss & ( 15 )\end{matrix}$$

Expression (15) represents calculating ∂Loss/∂(θ^{ns})ᵢ with respect to the elements (θ^{ns})ᵢ (1≤i≤|θ|) of θ^{ns}. The parameter updating unit 119 updates, for example, with a predetermined learning coefficient α (>0), (θ^{ns}), to (θ^{ns})ᵢ−α×∂Loss/∂(θ^{ns})ᵢ.

The learning unit 114 outputs, for example, the parameter vectors θ^{s}, θ₁^{ns}, . . . , θ_{K}^{ns} as a learning result after a predetermined number of learning cycles have been completed.

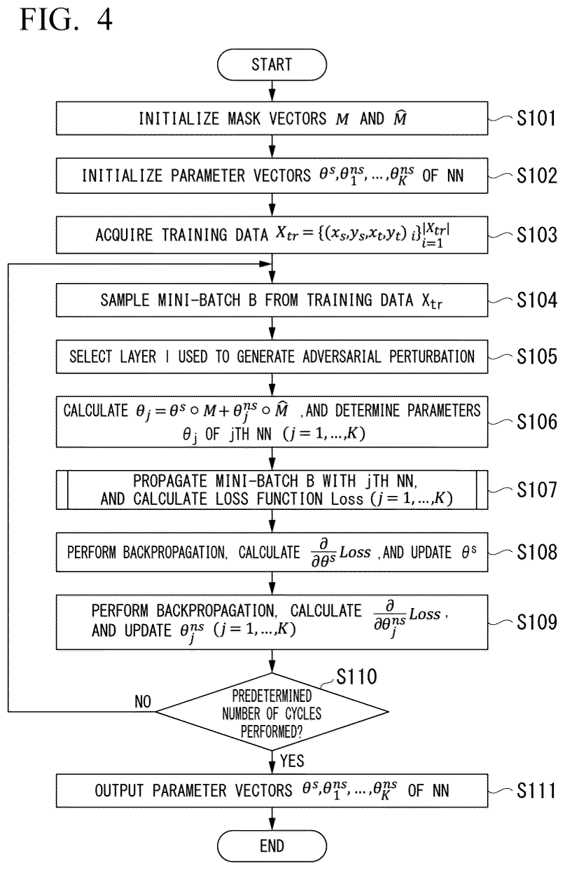

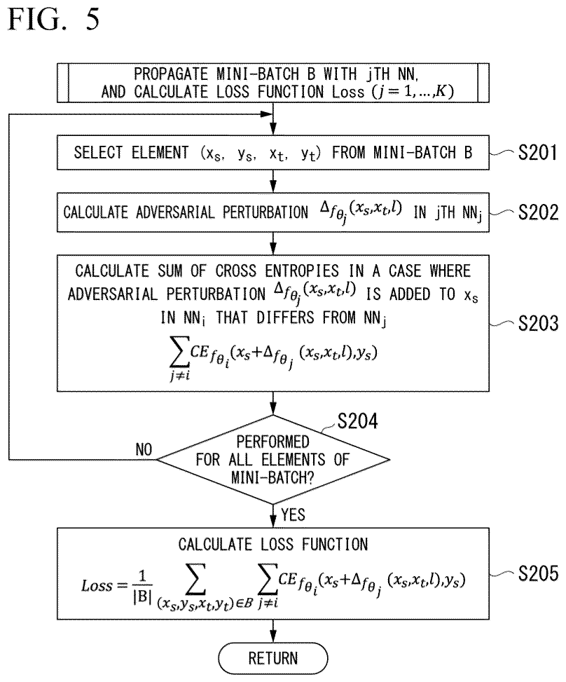

Next, the operation of the learning device 100 will be described with reference to FIG. 4 and FIG. 5. FIG. 4 is a flowchart showing an example of the processing procedure performed by the learning device 100 according to the first example embodiment. FIG. 5 is a flowchart showing an example of the processing procedure of a loss function calculation performed by the learning device 100.

First, the mask initialization unit 111 initializes the shared mask vector M and the non-shared mask vector \hat{ }M (step S101). The mask initialization unit 111, for example, randomly initializes the shared mask vector M, and initializes, as the non-shared mask vector \hat{ }M, a vector in which the 0 or 1 of each element of the mask vector M has been inverted.

Then, the parameter initialization unit 112 initializes the shared parameter vector θₛ and the non-shared parameter vectors θ₁^{ns}, . . . , θ_{K}^{ns} (step S102). The parameter initialization unit 112, for example, assigns a random number to each element of the parameter vectors.

Next, the training data acquisition unit 113 acquires the training data Xₜᵣ={(xₛ, yₛ, xₜ, yₜ)ᵢ} (1≤i≤K) that is stored in the training data storage unit 131 (step S103).

Then, the mini-batch sampling unit 115 samples a mini-batch B=(xₛ, yₛ, xₜ, yₜ) used in a single training cycle from the training data Xₜᵣ (step S104).

Next, the layer selection unit 116 selects one layer l of the neural network to be used to generate the adversarial perturbation Δf_{θj}(xₛ, xₜ, l) (step S105).

Then, the parameter determination unit 117 uses the shared mask vector M, the non-shared mask vector \hat{ }M, the shared parameter vector θ^{s}, and the non-shared parameter vectors θⱼ^{ns} (1≤j≤K) to determine (calculate) the parameter vector θⱼ=θ^{s}◯M+θⱼns◯\hat{ }M (1≤j≤K) of each neural network (step S106). Here, ◯ represents the Hadamard product. θ^{s} and θⱼ^{ns} (1≤j≤K) are vectors that have been initialized or updated.

The loss function calculation unit 118 propagates information of the mini-batch B={(xₛ, yₛ, xₜ, yₜ)} with each jth neural network (1≤j≤K), and calculates the loss function Loss in expression (13) (step S107).

The description now turns to FIG. 5. Next, the loss function calculation unit 118 selects one element (xₛ, yₛ, xₜ, yₜ) from the mini-batch B (step S201).

Then, the loss function calculation unit 118 calculates the adversarial perturbation Δf_{θj}(xₛ, xₜ, l) of the jth neural network (step S202).

Then, the loss function calculation unit 118 calculates, in the ith neural network that is different from the jth neural network, the sum of cross entropies Σ_{j≠i}CEf_{θi}(xₛ+Δf_{θj}(xₛ, xₜ, l), yₛ) in the case where the adversarial perturbation Δf_{θj}(xₛ, xₜ, l) is added to xₛ (step S203).

Next, the loss function calculation unit 118 determines whether or not the sum of cross entropies has been calculated for all of the elements of the mini-batch B (step S204). If the calculation has not been performed for all of the elements, the loss function calculation unit 118 returns the processing to step S201. On the other hand, if the calculation has been performed for all of the elements, the loss function calculation unit 118 shifts the processing to step S205.

Then, the loss function calculation unit 118 calculates the loss function Loss=(1/|B|)×Σ_{(xs,ys,xt,yt)∈B}Σ_{j≠i}CEf_{θi}(xₛ+Δf_{θj}(xₛ, xₜ, l), yₛ) (step S205).

The description now returns to FIG. 4. Next, the parameter updating unit 119 backpropagates the error information, calculates ∂Loss/∂θ^{s} by the gradient method, and updates θ^{s} (step S108).

In addition, the parameter updating unit 119 backpropagates the error information, calculates ∂Loss/∂θⱼ^{ns} by the gradient method, and updates θ^{ns} (j=1, . . . , K) (step S109).

Then, the learning unit 114 determines whether or not a predetermined number of learning cycles have been performed (step S110). If the predetermined number of learning cycles have not been performed, the learning unit 114 returns the processing to step S104. On the other hand, if the predetermined number of learning cycles have been performed, the learning unit 114 shifts the processing to step S111.

Next, the learning unit 114 (control unit 110) outputs the parameter vectors θ^{s}, θ₁^{ns}, . . . , θ_{K}^{ns} of the neural networks (step S111).

This completes the processing procedure of the learning device 100 according to the first example embodiment shown in FIG. 4 and FIG. 5.

In step S110, the completion condition of the learning is that a predetermined number of learning cycles has been performed. However, it is not limited to this. For example, the completion condition of the learning may be that the extent of the decrease in the loss function is smaller than a predetermined threshold.

As described above, the mask initialization unit 111 initializes the shared and non-shared mask vectors. The parameter initialization unit 112 initializes the parameter vectors. The training data acquisition unit 113 acquires training data. The mini-batch sampling unit 115 samples a mini-batch. The layer selection unit 116 selects a layer. The parameter determination unit 117 uses the shared and non-shared mask vectors to determine the parameter vectors. The loss function calculation unit 118 calculates the loss function. The parameter updating unit 119 updates the parameters. The learning unit 114 outputs the parameter vectors after a predetermined number of learning cycles have been completed.

As a result, the learning device 100 is capable of suppressing the number of parameters of the neural networks in the ensemble in ensemble-based robust training (ERT). Therefore, because the learning device 100 is capable of suppressing the storage capacity of the memory or the like, it is possible to increase the number of neural networks in the ensemble. Therefore, the learning device 100 is capable of improving the robustness in ensemble-based robust training.

Furthermore, the mask initialization unit 111 determines, for the parameters of the neural networks, a shared mask vector representing a distinction between the shared parameters provided for common use by the plurality of neural networks, and the non-shared parameters that are provided individually to each neural network. The loss function calculation unit 118 calculates, with respect to the training data, the value of the loss function based on the shared parameters, the non-shared parameters, and the plurality of neural networks to which the parameter values indicated by the shared mask vector have been applied. The parameter updating unit 119 updates the values of the shared parameters and the values of the non-shared parameters using the value of the loss function.

According to the learning device 100, some of the plurality of neural networks can be provided for common use. Therefore, according to the learning device 100, the number of parameter values to be stored by the determination device, which uses the plurality of trained neural networks, can be made relatively small.

In addition, the parameter determination unit 117 configures one neural network among the plurality of neural networks by setting, with respect to a model template containing a parameter vector in which the parameters for a single neural network are configured as a vector, and which is provided for common use by the plurality of neural networks, values of the shared parameters from the shared parameter vector for those elements among the elements of the parameter vector that are set as shared parameters by the shared mask vector, and by setting values of the non-shared parameters from the non-shared parameter vector for those elements among the elements of the parameter vector that are set as non-shared parameters by the shared mask vector.

According to the learning device 100, because the values of the shared parameters and the values of the non-shared parameters are both represented as vectors, the parameter values can be calculated by matrix calculations, which enables the calculations to be performed relatively quickly.

Furthermore, the mask initialization unit 111 determines the shared mask vector such that the shared parameters among the parameters of a single neural network are randomly selected.

As a result, the learning device 100 is capable of selecting the shared parameters among the parameters of a single neural network by the simple processing of a random selection. If the desired learning result cannot be obtained, the learning can be repeated, including the selection of the shared parameters by the mask initialization unit 111.

In addition, the loss function is a function that outputs a relatively small value if input data, in which an adversarial perturbation has been added that causes one neural network to make an incorrect determination, does not cause the other neural networks to make an incorrect determination.

As a result of the learning device 100 performing ensemble learning of the neural networks using such a loss function, it is expected that a determination device that is robust to an adversarial perturbation can be obtained. Specifically, it is expected that even if one of the neural networks obtained by ensemble learning performs an incorrect determination (incorrect class classification) with respect to input data to which an adversarial perturbation has been added, the other neural networks will perform a correct determination (correct class classification) with respect to the input data.

### Second Example Embodiment

In the ensemble-based robust training according to a second example embodiment, the positions of the shared parameters of the neural networks (NN) in the ensemble are also determined by learning. That is to say, in the ERT according to the second example embodiment, the parameters of the neural networks and the positions of the shared parameters are learned by solving the optimization problem in expression (23) below. In the second example embodiment, in order to also determine the positions of the shared parameters by learning, the positions of the shared parameters are changed during the learning. For example, the positions of the shared parameters indicated by ⊚ in FIG. 2 are changed during the learning. In all other respects, the second example embodiment is the same as the first example embodiment.

The shared parameters and the non-shared parameters in the second example embodiment are the same as in the first example embodiment. As in the first example embodiment, if the number of neural networks in the ensemble is K, the shared vector and the non-shared vector can be expressed as in expression (16).

$$\begin{matrix}[ Expression 16 ] & \\ {θ}^{s} , {θ}_{1}^{ns} , … , {θ}_{K}^{ns} ∈ {R}^{\vert θ \vert} & ( 16 )\end{matrix}$$

The shared mask vector M in the second example embodiment is the same as in the first example embodiment.

On the other hand, in the second example embodiment, a real number vector corresponding to the shared mask vector M is provided. The real number vector is also referred to as a substitution vector of the shared mask vector M, or simply a substitution vector, and is denoted by S. S is a variable (variable vector), and is also referred to as a substitution variable.

The shared mask vector M and the substitution vector S can be expressed as in expression (17).

$$[ Expression 17 ]$$

$$M ∈ {\{ 0 , 1 \}}^{\vert θ \vert} , S ∈ {[ 0 , 1 ]}^{\vert θ \vert} \qquad ( 17 )$$

M is a |θ|-dimensional vector whose elements are 0 or 1, and 1 represents a shared position.

Because the elements of the shared mask vector M are discrete values, direct optimization using a learning method that uses differentiation, such as error backpropagation, is difficult. Therefore, the optimization is performed using a substitution variable (substitution vector) S of M, whose elements take continuous values. S is a |θ|-dimensional vector whose elements are real number values of 0 or more and 1 or less. After optimizing S, the shared mask vector M is determined by setting the values of the elements at the positions of the m largest element values (0≤m≤|θ|) to 1, and the other elements to 0. Here, p represents the proportion of shared parameters. p can be expressed as in expression (18).

$$[ Expression 18 ]$$

$$p = \frac{m}{\vert θ \vert} \qquad ( 18 )$$

m can be set to a positive integer determined in advance.

The non-shared mask vector \hat{ }M in the second example embodiment is the same as in the first example embodiment.

The real number vector corresponding to the non-shared mask vector \hat{ }M can be calculated by 1−S. The real number vector is also referred to as a substitution vector of the non-shared mask vector \hat{ }M, or simply a substitution vector, and is denoted by 1−S or \hat{ }S. Furthermore, because S is referred to as a substitution variable, 1−S and \hat{ }S are also referred to as substitution variables. A variable corresponding to \hat{ }S may be provided, and 1−S may be substituted into the variable.

The non-shared mask vector \hat{ }M and the substitution vector \hat{ }S can be expressed as in expression (19).

$$[ Expression 19 ]$$

$$\hat{M} ∈ {\{ 0 , 1 \}}^{\vert θ \vert} , \hat{S} ∈ {[ 0 , 1 ]}^{\vert θ \vert} , \hat{S} = 1 - S \qquad ( 19 )$$

\hat{ }M is also a |θ|-dimensional vector whose elements have values of 0 or 1, and 1 represents a non-shared position. \hat{ }M is a vector that is obtained by inverting the 0 and 1 values of M.

The substitution variable \hat{ }S corresponding to the non-shared mask vector \hat{ }M is also a |θ|-dimensional vector whose elements are real number values of 0 or more and 1 or less. The value of each element of \hat{ }S is the value obtained by subtracting the value of the element in the corresponding position in S from 1.

The shared parameter vector M may be calculated from the substitution vector S at the time of learning. In this case, as in the first example embodiment, the extraction of the shared parameters from the shared parameter vector θ^{s} can be performed using the shared mask vector M, and can be expressed as in expression (4) above. A case where the shared parameters are extracted from the shared parameter vector θ^{s} using the shared mask vector M in this way will be described in a third example embodiment.

On the other hand, in the second example embodiment, the elements of the substitution vector S are used as coefficients by which the shared parameters are multiplied. The multiplication of the elements of the substitution vector S by the shared parameters can be expressed as in expression (20).

$$[ Expression 20 ]$$

$${θ}^{s} ◦ S \qquad ( 20 )$$

As mentioned above, ◯ represents the Hadamard product, which calculates the element-wise product of vectors.

If the shared parameter vector M is calculated from the substitution vector S at the time of learning, as in the first example embodiment, extraction of the non-shared parameters from the non-shared parameter vector θⱼ^{ns} of the jth neural network can be performed using the non-shared mask vector \hat{ }M, and can be expressed as in expression (5) above. The calculation of the parameter vector θⱼ of the jth neural network can be performed in the same manner as in the first example embodiment, and can be expressed as in expression (6). Such a processing method can be used in the third example embodiment described below.

On the other hand, in the second example embodiment, the elements of the non-substitution vector 1−S are used as coefficients by which the non-shared parameters are multiplied. The multiplication of the elements of the non-substitution vector 1−S with the non-shared parameters of the jth neural network can be expressed as in expression (21).

$$[ Expression 21 ]$$

$${θ}_{j}^{ns} ◦ ( 1 - S ) \qquad ( 21 )$$

As described above, ◯ represents the Hadamard product.

In the second example embodiment, the parameter vectors are calculated by adding the values obtained by multiplying the elements of the substitution vector S and the shared parameters, and the values obtained by multiplying the elements of the non-substitution vector 1−S and the non-shared. The parameter vector θⱼ of the jth neural network can be expressed as in expression (22).

$$[ Expression 22 ]$$

$${θ}_{j} = {θ}^{s} ◦ S + {θ}_{j}^{ns} ◦ ( 1 - S ) \qquad ( 22 )$$

Next, the optimization problem in expression (23) will be described.

$$[ Expression 23 ]$$

$${arg min}_{M ( or S ) , {θ}^{s} , {θ}_{1}^{ns} , … , {θ}_{K}^{ns}} {E}_{( {x}_{s} , {y}_{s} ) , ( {x}_{t} , {y}_{t} ) , l} {\sum }_{j \neq i} {CE}_{{f}_{{θ}_{i}}} ( {x}_{s} + {Δ}_{{f}_{{θ}_{j}}} ( {x}_{s} , {x}_{t} , l ) , {y}_{s} ) \qquad ( 23 )$$

In expression (23), “xₛ” represents input data to the neural network, such as image data, and “yₛ” represents the correct class label (class value) of xₛ. Similarly, “xₜ” represents input data to the neural network, and “yₜ” represents the correct class label of xₜ. Here, it is assumed that “xₛ” and “xₜ” represent input data belonging to different classes. That is to say, yₛ≠yₜ.

“Δf_{θj}(xₛ, xₜ, l)” represents an adversarial perturbation (noise), and is the same as that calculated by expression (8) in the first example embodiment. In other words, in terms of the output of the lth layer of the jth neural network, “Δf_{θj}(xₛ, xₜ, l)” is the minimum noise that causes xₛ to be incorrectly determined as xₜ.

“xₛ+Δf_{θj}(xₛ, xₜ, l)” represents the input data obtained by adding the adversarial perturbation Δf_{θj}(xₛ, xₜ, l) obtained in expression (8) to xₛ.

“CEf_{θi}(x, y)” is a cross entropy loss function, which is a function that, given input data x and a class label y, outputs a smaller value as the ith neural network using the parameter vector θᵢ more correctly classifies x as y. Therefore, “CEf_{θi}(xₛ+Δf_{θj}(xₛ, xₜ, l), yₛ)” is a function that, even if an adversarial perturbation is added to xₛ so as to cause the lth layer of the jth neural network using the parameter vector θj to make an incorrect determination, outputs a smaller value as the ith neural network using the parameter vector θᵢ more correctly makes the determination of yₛ.

“Σ_{j≠i}CEf_{θi}(⋅, ⋅)” represents calculating the cross entropy of all neural networks that are different from the jth neural network, and then calculating the total sum.

“E_{(xs,ys),(xt,yt),l}Σ_{j≠i}CEf_{θi}(⋅, ⋅)” represents taking the expected value of the total sum of the cross entropies with respect to (xₛ, yₛ), (xₜ, yₜ), and l.

“argmin_{M (or S), θ^{s}, θ₁^{ns}, . . . , θ_{K}^{ns}}E_{(xs,ys),(xt,yt),l}Σ_{j≠i}CEf_{θi}(⋅, ⋅)” represents calculating the parameter vectors θ^{s}, θ₁^{ns}, . . . , θ_{K}^{ns} of each neural network and the shared mask vector M that minimize the expected value of the total sum of the cross entropies mentioned above.

In the second example embodiment and in the third example embodiment, the substitution vector S, rather than the shared mask vector M, is used as one of the targets for which values are calculated in the optimization. As mentioned above, because the shared mask vector M takes discrete values, it is not possible to apply a method that uses differentiation, such as error backpropagation, as the method of solving the optimization problem. Therefore, the optimization problem is configured using the substitution vector S instead of the shared mask vector M, and the shared mask vector M is calculated from the obtained substitution vector S.

In the second example embodiment, the shared mask vector M is obtained from the substitution vector S obtained at the end of learning according to the proportion p represented by expression (18) above.

On the other hand, in the third example embodiment described below, the values of the substitution vector S are updated if the values of the parameter vector θⱼ of the jth neural network (1≤j≤K) are updated using error backpropagation. Further, the shared mask vector M is obtained from the updated substitution vector S according to the proportion p represented by expression (18) above. Also, as in the first example embodiment, the obtained shared mask vector (updated shared mask vector) is used to update the shared parameter vector θ^{s} and the non-shared parameter vector θⱼ^{ns}.

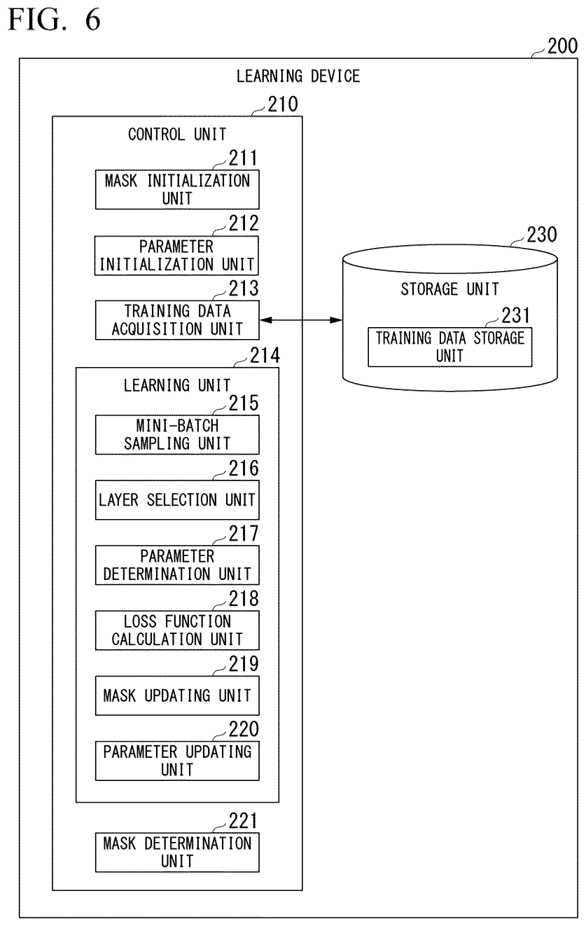

FIG. 6 is a schematic block diagram showing an example of a functional configuration of a learning device 200 according to the second example embodiment. The learning device 200 includes a control unit 210 and a storage unit 230. The control unit 210 includes a mask initialization unit 211, a parameter initialization unit 212, a training data acquisition unit 213, a learning unit 214, and a mask determination unit 221. The learning unit 214 includes a mini-batch sampling unit 215, a layer selection unit 216, a parameter determination unit 217, a loss function calculation unit 218, a mask updating unit 219, and a parameter updating unit 220. The storage unit 230 includes a training data storage unit 231. The learning device 200 may include other units. Furthermore, the storage unit 230 may be provided outside the learning device 200.

In the ensemble-based robust training (ERT) according to the second example embodiment, the positions of the shared parameters of the neural networks (NN) in the ensemble are determined by learning, and the parameters of the neural networks are learned. As mentioned above, the number of neural networks in the ensemble is K.

The mask initialization unit 211 initializes the substitution variable (substitution vector) S corresponding to the shared mask vector M. The mask initialization unit 211 corresponds to an example of a mask initialization means.

As mentioned above, the substitution variables S and \hat{ }Sᵣ can be expressed as in expression (24).

$$[ Expression 24 ]$$

$$S ∈ {[ 0 , 1 ]}^{\vert θ \vert} , \hat{S} ∈ {[ 0 , 1 ]}^{\vert θ \vert} , \hat{S} = 1 - S \qquad ( 24 )$$

Specifically, the mask initialization unit 211 randomly initializes the substitution variable S. The elements of S are real number values of 0 or more and 1 or less. Alternatively, the initial values of the substitution variable S may be determined in advance, and the mask initialization unit 211 may store the initial values of the substitution variable S in advance.

The parameter initialization unit 212 is the same as the parameter initialization unit 112. The parameter initialization unit 212 initializes the shared parameter vector θₛ and each of the non-shared parameter vectors θ₁^{ns}, . . . , θ_{K}^{ns}. As mentioned above, the shared parameters and the non-shared parameters can be expressed as in expression (25).

$$[ Expression 25 ]$$

$${θ}^{s} , {θ}_{1}^{ns} , … , {θ}_{K}^{ns} ∈ {R}^{\vert θ \vert} \qquad ( 25 )$$

For example, the parameter initialization unit 212 randomly initializes the parameter values by assigning random numbers to each element of the parameter vectors. Alternatively, the initial values of the parameters may be determined in advance, and the parameter initialization unit 112 may store the initial values of the parameters as the initial values of the elements of the parameter vectors in advance.

The training data storage unit 231 is the same as the training data storage unit 131. The training data storage unit 231 stores (a set of) training data Xₜᵣ used for training the neural networks.

As mentioned above, the training data Xₜᵣ can be expressed as in expression (26).

$$[ Expression 26 ]$$

$${X}_{tr} = {\{ {( {x}_{s} , {y}_{s} , {x}_{t} , {y}_{t} )}_{i} \}}_{i = 1}^{\vert {X}_{tr} \vert} \qquad ( 26 )$$

The learning unit 214 uses the training data Xₜᵣ to update and learn the parameter vectors of the neural networks in the ensemble and the substitution variable S of the shared mask vector, using iterative error backpropagation.

The mini-batch sampling unit 215 is the same as the mini-batch sampling unit 115. The mini-batch sampling unit 215 samples, from the training data Xₜᵣ, a mini-batch B used in a single learning cycle. Specifically, the mini-batch sampling unit 215 randomly samples a subset from the training data Xₜᵣ to generate the mini-batch B.

The layer selection unit 216 is the same as the layer selection unit 116. The layer selection unit 216 selects one layer l of the neural network to be used to generate the adversarial perturbation Δf_{θj}(xₛ, xₜ, l).

The parameter determination unit 217 determines the parameter vector with respect to each neural network. The parameter determination unit 217 corresponds to an example of a parameter determination means.

As mentioned above, the parameter vector θⱼ of the jth neural network can be expressed as in expression (27).

$$[ Expression 27 ]$$

$${θ}_{j} = {θ}^{s} ◦ S + {θ}_{j}^{ns} ◦ ( 1 - S ) \qquad ( 27 )$$

Specifically, the parameter determination unit 117 uses the substitution variable S corresponding to the shared mask vector, the substitution variable \hat{ }S=1−S corresponding to the non-shared mask vector, the shared parameter vector θ^{s}, and the non-shared parameter vectors θⱼⁿs (1≤j≤K) to determine (calculate) the parameter vector θⱼ (1≤j≤K) of each neural network. S, θ^{s} and θⱼ^{ns} (1≤j≤K) are vectors that have been initialized or updated.

The loss function calculation unit 218 is the same as the loss function calculation unit 118. The loss function calculation unit 218 corresponds to an example of a loss function calculation means.

The loss function calculation unit 218 propagates information of the mini-batch B={(xₛ, yₛ, xₜ, yₜ)} with each jth neural network (1≤j≤K), and calculates the loss function Loss in expression (28).

$$[ Expression 28 ]$$

$$Loss = \frac{1}{\vert B \vert} {\sum }_{( {x}_{s} , {y}_{s} , {x}_{t} , {y}_{t} ) ∈ B} {\sum }_{j \neq i} {CE}_{{f}_{{θ}_{i}}} ( {x}_{s} + {Δ}_{{f}_{{θ}_{j}}} ( {x}_{s} , {x}_{t} , l ) , {y}_{s} ) \qquad ( 28 )$$

The loss function Loss in expression (28) is the same as the loss function Loss in expression (13).

The mask updating unit 219 updates the substitution variable S by backpropagating error information by error backpropagation. The mask updating unit 219 corresponds to an example of a mask updating means.

Specifically, the mask updating unit 219 calculates a partial derivative of the loss function Loss shown in expression (29), and updates S.

$$[ Expression 29 ]$$

$$\frac{\partial }{\partial S} Loss \qquad ( 29 )$$

Expression (29) represents calculating ∂Loss/∂Sᵢ with respect to the elements Sᵢ (1≤i≤|θ|) of S. The mask updating unit 219 updates, for example, with a predetermined α (>0), Sᵢ to Sᵢ−α×∂Loss/∂Sᵢ.

Furthermore, the mask updating unit 219 performs an adjustment such that Sᵢ takes a value in the range of [0, 1]. For example, if the calculated value of Sᵢ is Sᵢ<0, the mask updating unit 219 sets the updated value of Sᵢ to 0. Furthermore, if the calculated value of Sᵢ is Sᵢ>1, the mask updating unit 219 sets the updated value of Sᵢ to 1.

The parameter updating unit 220 is the same as the parameter updating unit 119. The parameter updating unit 220 corresponds to an example of a parameter updating means.

The parameter updating unit 220 updates parameters by backpropagating error information by error backpropagation. Specifically, the parameter updating unit 220 calculates a partial derivative of the loss function Loss shown in expression (30), and updates θ^{s}.

$$[ Expression 30 ]$$

$$\frac{\partial }{\partial {θ}^{s}} Loss \qquad ( 30 )$$

Expression (30) is the same as expression (14). The parameter updating unit 220 updates, for example, with a predetermined learning coefficient α (>0), (θ^{s})ᵢ to (θs)ᵢ−α×∂Loss/∂(θ^{s})ᵢ.

Furthermore, the parameter updating unit 220 calculates a partial derivative of the loss function Loss shown in expression (31), and updates θ^{ns} (j=1, . . . , K).

$$[ Expression 31 ]$$

$$\frac{\partial }{\partial {θ}_{j}^{ns}} Loss \qquad ( 31 )$$

Expression (31) is the same as expression (15). The parameter updating unit 220 updates, for example, with a predetermined learning coefficient α (>0), (θ^{ns})ᵢ to (θ^{ns})ᵢ−α×∂Loss/∂(θ^{ns})ᵢ.

The learning unit 214 outputs the parameter vectors θ^{s}, θ₁^{ns}, . . . , θ_{K}^{ns} and the substitution variable S as a learning result after a predetermined number of learning cycles have been completed.

The mask determination unit 221 determines the mask vector M. Specifically, the mask determination unit 221 determines the mask vector M such that, for the substitution variable S output from the learning unit 214, the m (=p×|θ|) positions having the largest values are set to 1, and the other positions are set to 0. Here, p represents the proportion of shared parameters represented by expression (18).

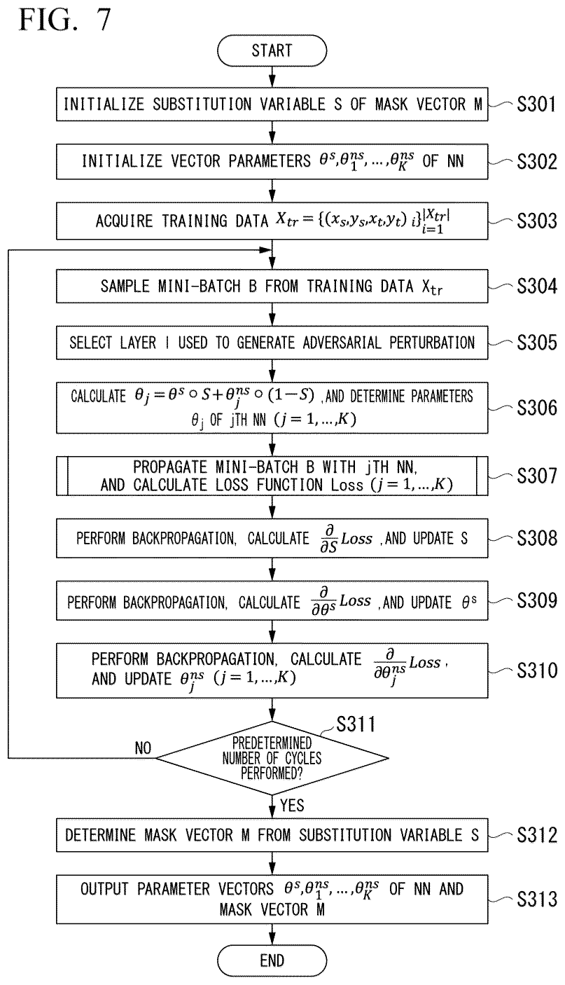

Next, the operation of the learning device 200 according to the second example embodiment will be described with reference to FIG. 7. FIG. 7 is a flowchart showing an example of the processing procedure performed by the learning device 200 according to the second example embodiment. In the processing procedure of the second example embodiment, updating of the parameter vectors θ^{s}, θ₁^{ns}, . . . , θ_{K}^{ns} and the substitution variable S is performed simultaneously in each learning cycle.

First, the mask initialization unit 211 initializes the substitution variable (substitution vector) S corresponding to the shared mask vector M (step S301). The mask initialization unit 211, for example, randomly initializes the substitution variable S.

Then, the parameter initialization unit 212 initializes the shared parameter vector θₛ and the non-shared parameter vectors θ₁^{ns}, . . . , θ_{K}^{ns} (step S302). The parameter initialization unit 212, for example, performs a random initialization by assigning random numbers to each element of the parameter vectors.

Next, the training data acquisition unit 213 acquires the training data Xₜᵣ={(xₛ, yₛ, xₜ, yₜ)ᵢ} (1≤i≤K) that is stored in the training data storage unit 231 (step S303).

Then, the mini-batch sampling unit 215 samples a mini-batch B={(xₛ, yₛ, xₜ, yₜ)} used in a single learning cycle from the training data Xₜᵣ (step S304).

Next, the layer selection unit 216 selects one layer l of the neural network to be used to generate the adversarial perturbation Δf_{θj}(xₛ, xₜ, l) (step S305).

Then, the parameter determination unit 217 uses the substitution variable S of the shared mask vector, the substitution variable \hat{ }S=1−S of the non-shared mask vector, the shared parameter vector θ^{s}, and the non-shared parameter vectors θⱼ^{ns} (1≤j≤K) to determine (calculate) the parameter vector θⱼ=θ^{s}◯M+θⱼ^{ns} ◯\hat{ }M (1≤j≤K) of each neural network (step S306). As described above, ◯ represents the Hadamard product. S, θ^{s} and θⱼ^{ns} (1≤j≤K) are vectors that have been initialized or updated.

The loss function calculation unit 218 propagates information of the mini-batch B={(xₛ, yₛ, xₜ, yₜ)} with each jth neural network (1≤j≤K), and calculates the loss function Loss=(1/|B|)×Σ_{(xs,ys,xt,yt)∈B}Σ_{j≠i}CEf_{θi}(xₛ+Δf_{θj}(xₛ, xₜ, l), yₛ) in expression (28) (step S307). The calculation of the loss function Loss is the same as the processing procedure of the loss function calculation shown in FIG. 5 in the first example embodiment, except that the meaning of the parameter vector θⱼ (1≤j≤K) is different.

Next, the mask updating unit 219 backpropagates the error information, calculates ∂Loss/∂S by the gradient method, and updates S (step S308).

Next, the parameter updating unit 220 backpropagates the error information, calculates ∂Loss/∂θ^{s}, and updates θ^{s} (step S309).

In addition, the parameter updating unit 220 backpropagates the error information, calculates ∂Loss/∂θⱼ^{ns}, and updates θ^{ns} (j=1, . . . , K) (step S310).

Then, the learning unit 214 determines whether or not a predetermined number of learning cycles have been performed (step S311). If the predetermined number of learning cycles have not been performed, the learning unit 214 returns the processing to step S304. On the other hand, if the predetermined number of learning cycles have been performed, the learning unit 214 shifts the processing to step S312.

Next, the mask determination unit 221 determines the mask vector M such that, for the substitution variable S, the m=p×|θ| positions having the largest values are set to 1, and the other positions are set to 0 (step S312).

Next, the learning unit 214 (control unit 210) outputs the parameter vectors θ^{s}, θ₁^{ns}, . . . , θ_{K}^{ns} of the neural networks and the mask vector M (step S313).

This completes the processing procedure of the learning device 200 according to the second example embodiment shown in FIG. 7.

In step S310, the completion condition of the learning is that a predetermined number of learning cycles has been performed. However, it is not limited to this. For example, the completion condition of the learning may be that the extent of the decrease in the loss function is smaller than a predetermined threshold.

As described above, the mask initialization unit 211 initializes the substitution variable S. The parameter initialization unit 212 initializes the parameter vectors. The training data acquisition unit 213 acquires training data. The mini-batch sampling unit 215 samples a mini-batch. The layer selection unit 216 selects a layer. The parameter determination unit 217 uses the substitution variables S and \hat{ }S=1−S to determine the parameter vectors. The loss function calculation unit 218 calculates the loss function. The mask updating unit 219 updates the substitution variable S. The parameter updating unit 220 updates the parameters. The learning unit 214 outputs the parameter vectors and the substitution variable S after a predetermined number of learning cycles have been completed. The mask determination unit 221 determines the mask vector from the substitution variable S.

As a result, the learning device 200 is capable of suppressing the number of parameters of the neural networks in the ensemble in ensemble-based robust training (ERT). Therefore, because the learning device 200 is capable of suppressing the storage capacity of the memory or the like, it is possible to increase the number of neural networks in the ensemble. Therefore, the learning device 200 is capable of improving the robustness in ensemble-based robust training.

Furthermore, because the learning device 200 determines the positions of the shared parameters (mask vector) by learning, it is capable of more appropriately determining the positions and number of shared parameters. In addition, the learning device 200 according to the second example embodiment is capable of faster processing than the processing method of the third example embodiment described below.

Moreover, the shared mask vector has continuous values for each parameter of a single neural network. The mask updating unit 219 updates the values of each parameter in the shared mask vector (the values of the elements of the shared mask vector) using the value of the loss function.

According to the learning device 200, in addition to the values of the parameters of the neural network, it is also possible to learn the parameters set as shared parameters, and the positions in the structure of the neural network. According to the learning device 200, in this respect, it is expected that learning can be performed with a higher accuracy.

### Third Example Embodiment

In the ensemble-based robust training according to the third example embodiment, as in the second example embodiment, the positions of the shared parameters of the neural networks (NN) in the ensemble are also determined by learning. That is to say, in the ERT according to the third example embodiment, the parameters of the neural networks and the positions of the shared parameters are learned by solving the optimization problem in expression (23) above. In the third example embodiment, in order to also determine the positions of the shared parameters by learning, the positions of the shared parameters are changed during the learning. For example, the positions of the shared parameters indicated by ⊚ in FIG. 2 are changed during the learning.

As described above, in the third example embodiment, in the case where the shared parameter vector and the non-shared parameter vectors are updated by error backpropagation, the shared mask vector is calculated (updated) from the updated substitution vector S, and the calculated shared mask vector is used to calculate the parameter values of the neural networks and calculate the error. In all other respects, the third example embodiment is the same as the second example embodiment.

The schematic block diagram showing an example of the functional configuration of the learning device 200 according to the third example embodiment is the same as the schematic block diagram showing an example of the functional configuration of the learning device 200 according to the second example embodiment shown in FIG. 6.

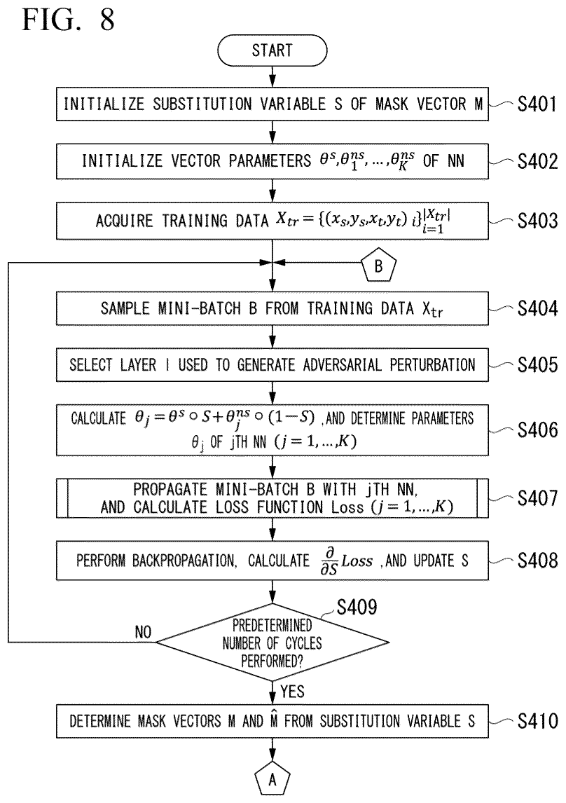

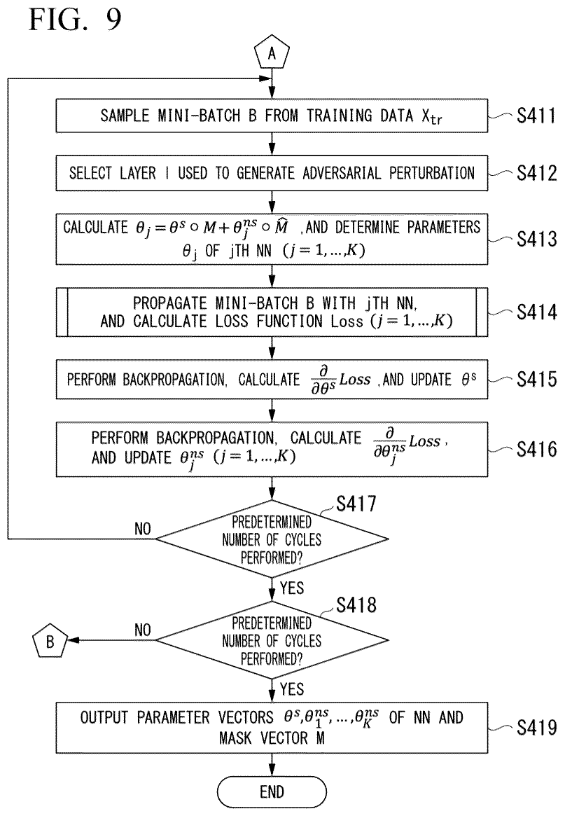

Next, the operation of the learning device 200 according to the third example embodiment will be described with reference to FIG. 8 and FIG. 9. FIG. 8 and FIG. 9 are flowcharts showing an example of the processing procedure performed by the learning device 200 according to the third example embodiment. In the processing procedure of the third example embodiment, the learning of the substitution variable S is firstly performed. Then, the mask vectors M and \hat{ }M are determined from the substitution variable S, and these are used to learn the parameter vectors θ^{s}, θ₁^{ns}, . . . , θ_{K}^{ns}.

First, the mask initialization unit 211 initializes the substitution variable (substitution vector) S corresponding to the shared mask vector M (step S401). The mask initialization unit 211, for example, randomly initializes the substitution variable S.

Then, the parameter initialization unit 212 initializes the shared parameter vector θₛ and the non-shared parameter vectors θ₁^{ns}, . . . , θ_{K}^{ns} (step S402). The parameter initialization unit 212, for example, performs a random initialization by assigning random numbers to each element of the parameter vectors.

Next, the training data acquisition unit 213 acquires the training data Xₜᵣ={(xₛ, yₛ, xₜ, yₜ)ᵢ} (1≤i≤K) that is stored in the training data storage unit 231 (step S403).

Then, the mini-batch sampling unit 215 samples a mini-batch B={(xₛ, yₛ, xₜ, yₜ)} used in a single learning cycle (steps S404 to S408, referred to as learning A below) from the training data Xₜᵣ (step S404).

Next, the layer selection unit 216 selects one layer l of the neural network to be used to generate the adversarial perturbation Δf_{θj}(xₛ, xₜ, l) (step S405).

Then, the parameter determination unit 217 uses the substitution variable S of the shared mask vector, the substitution variable \hat{ }S=1−S of the non-shared mask vector, the shared parameter vector θ^{s}, and the non-shared parameter vectors θⱼ^{ns} (1≤j≤K) to determine (calculate) the parameter vector θⱼ=θ^{s}◯S+θⱼ^{ns}◯\hat{ }S (1≤j≤K) of each neural network (step S406). Here, ◯ represents the Hadamard product. S is a vector that has been initialized or updated.

The loss function calculation unit 218 propagates information of the mini-batch B={(xₛ, yₛ, xₜ, yₜ)} with each jth neural network (1≤j≤K), and calculates the loss function Loss=(1/|B|)×Σ_{(xs,ys,xt,yt)∈B}Σ_{j≠i}CEf_{θi}(xₛ+Δf_{θj}(xₛ, xₜ, l), yₛ) in expression (28) (step S407). The calculation of the loss function Loss performed by the loss function calculation unit 218 is the same as the processing procedure of the loss function calculation shown in FIG. 5 in the first example embodiment, except that the meaning of the parameter vector θⱼ (1≤j≤K) is different.

Next, the mask updating unit 219 backpropagates the error information, calculates ∂Loss/∂S by the gradient method, and updates S (step S408).

Then, the learning unit 214 determines whether or not a predetermined number of cycles of the learning A have been performed (step S409). If the predetermined number of cycles of the learning A have not been performed, the learning unit 214 returns the processing to step S404. On the other hand, if the predetermined number of cycles of the learning A have been performed, the learning unit 214 shifts the processing to step S410.

Next, the mask determination unit 221 determines the mask vector M such that, for the substitution variable S, the m=p×|θ| positions having the largest values are set to 1, and the other positions are set to 0 (step S410). Furthermore, the mask determination unit 221 determines a vector in which the 0 or 1 of each element of the mask vector M has been inverted as the non-shared mask vector \hat{ }M (step S410).

Then, the mini-batch sampling unit 215 samples a mini-batch B={(xₛ, yₛ, xₜ, yₜ)} used in a single learning cycle (steps S411 to S416, referred to as learning B below) from the training data Xₜᵣ (step S411).

Next, the layer selection unit 216 selects one layer l of the neural network to be used to generate the adversarial perturbation Δf_{θj}(xₛ, xₜ, l) (step S412).

Then, the parameter determination unit 217 uses the shared mask vector M, the non-shared mask vector \hat{ }M, the shared parameter vector θ^{s}, and the non-shared parameter vectors θⱼ^{ns} (1≤j≤K) to determine (calculate) the parameter vector θⱼ=θ^{s}◯M+θⱼ^{ns}◯\hat{ }M (1≤j≤K) of each neural network (step S413). Here, ◯ represents the Hadamard product. θ^{s} and θⱼ^{ns} (1≤j≤K) are vectors that have been initialized or updated.

The loss function calculation unit 218 propagates information of the mini-batch B={(xₛ, yₛ, xₜ, yₜ)} with each jth neural network (1≤j≤K), and calculates the loss function Loss=(1/|B|)×Σ_{(xs,ys,xt,yt)∈B}Σ_{j≠i}CEf_{θi}(xₛ+Δf_{θj}(xₛ, xₜ, l), y) in expression (28) (step S414). The calculation of the loss function Loss performed by the loss function calculation unit 218 is the same as the processing procedure of the loss function calculation shown in FIG. 5 in the first example embodiment, except that the meaning of the parameter vector θⱼ (1≤j≤K) is different.

Next, the parameter updating unit 220 backpropagates the error information, calculates ∂Loss/∂θ^{s}, and updates θ^{s} (step S415).

In addition, the parameter updating unit 220 backpropagates the error information, calculates ∂Loss/∂θⱼ^{ns}, and updates θ^{ns} (j=1, . . . , K) (step S416).

Then, the learning unit 214 determines whether or not a predetermined number of cycles of the learning B have been performed (step S417). If the predetermined number of cycles of the learning B have not been performed, the learning unit 214 returns the processing to step S411. On the other hand, if the predetermined number of cycles of the learning B have been performed, the learning unit 214 shifts the processing to step S417.

Then, the learning unit 214 further determines whether or not a predetermined number of cycles of the learning A and the learning B have been performed (step S418). If the predetermined number of cycles of the learning A and the learning B have not been performed, the learning unit 214 returns the processing to step S404. On the other hand, if the predetermined number of cycles of the learning A and the learning B have been performed, the learning unit 214 shifts the processing to step S419.

Next, the learning unit 214 (control unit 210) outputs the parameter vectors θ^{s}, θ₁^{ns}, . . . , θ_{K}^{ns} of the neural networks and the mask vector M (step S419).

This completes the processing procedure of the learning device 200 according to the third example embodiment shown in FIG. 8 and FIG. 9.

In step S418, the completion condition of the learning A and the learning B may be one learning cycle. Furthermore, the completion condition of the learning in steps S409, S417, and S418 is the completion of a predetermined number of learning cycles. However, for example, the completion condition of the learning may be that the extent of the decrease in the loss function is smaller than a predetermined threshold.

As described above, the mask initialization unit 211 initializes the substitution variable S. The parameter initialization unit 212 initializes the parameter vectors. The training data acquisition unit 213 acquires training data. In the learning A, the mini-batch sampling unit 215 samples a mini-batch. The layer selection unit 216 selects a layer. The parameter determination unit 217 uses the substitution variables S and \hat{ }S=1−S to determine the parameter vectors. The loss function calculation unit 218 calculates the loss function. The mask updating unit 219 updates the substitution variable S. After the learning unit 214 has performed the predetermined number of cycles of the learning A, the mask determination unit 221 determines the mask vector from the substitution variable S. Further, in the learning B, the mini-batch sampling unit 215 samples a mini-batch. The layer selection unit 216 selects a layer. The parameter determination unit 217 uses the mask vectors M and \hat{ }M to determine the parameter vectors. The loss function calculation unit 218 calculates the loss function. The parameter updating unit 220 updates the parameters. After the learning unit 214 has performed the predetermined number of cycles of the learning B, the learning unit 214 further performs a predetermined number of cycles of the learning A and the learning B, and then outputs the parameter vectors and the mask vector M.

As a result, the learning device 200 is capable of suppressing the number of parameters of the neural networks in the ensemble in ensemble-based robust training (ERT). Therefore, because the learning device 200 is capable of suppressing the storage capacity of the memory or the like, it is possible to increase the number of neural networks in the ensemble. Therefore, the learning device 200 is capable of improving the robustness in ensemble-based robust training.

Furthermore, because the learning device 200 determines the positions of the shared parameters (mask vector) by learning, it is capable of more appropriately determining the positions and number of shared parameters. In addition, the learning device 200 according to the third example embodiment is capable of more accurate processing than the processing method of the second example embodiment described above.

### Fourth Example Embodiment

In a fourth example embodiment, an example of a determination device using the neural networks trained by the learning devices 100 and 200 according to the first to third example embodiments will be described.

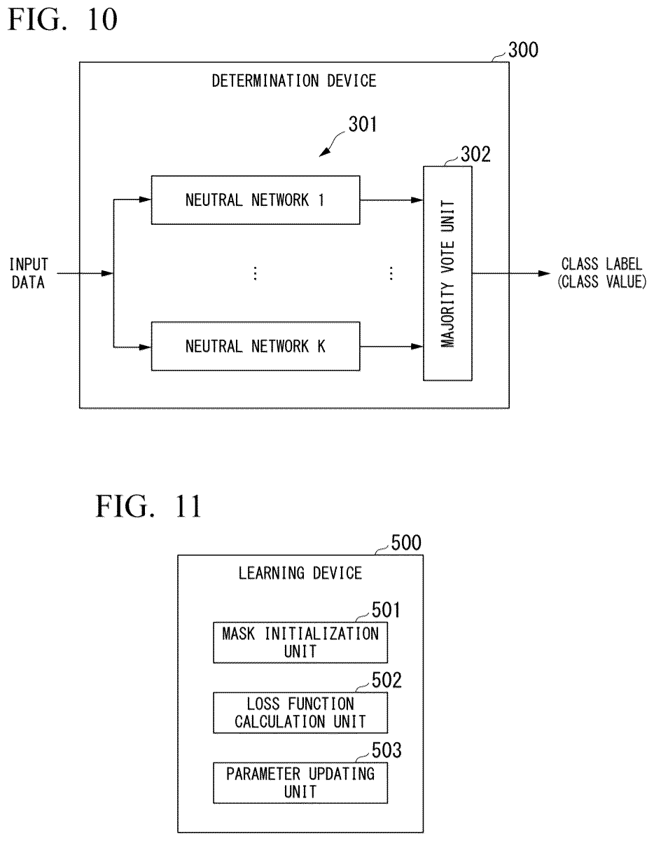

FIG. 10 is a schematic block diagram showing an example of a functional configuration of a determination device 300 according to the fourth example embodiment. The determination device 300 includes a plurality of neural networks 301 (neural network 1, . . . , neural network K) and a majority vote unit 302.

The neural networks 301 are the neural network 1, . . . , neural network K that have been trained by the learning devices 100 and 200 according to the first to third example embodiments. The neural networks (1≤i≤K) share parameters (a parameter vector). Each of the neural networks i output a class label (class value) in response to an input of input data such as image data.

If the class labels (class values) are input from the plurality of neural networks 301, the majority vote unit 302 takes a majority vote (obtains the most common class label), and outputs the result as the class label. The majority vote unit 302 may apply a weight to the inputs from the plurality of neural networks 301. Furthermore, rather than taking a majority vote of the inputs from the plurality of neural networks 301, the majority vote unit 302 may output a result by calculating a value using another function.

According to the fourth example embodiment, the neural network 1, . . . , neural network K that have been trained by the learning devices 100 and 200 of the first to third example embodiments calculate a class label from the input data, and the majority vote unit 302 outputs a result by taking a majority vote of the class labels.

As a result, it is possible to perform a determination (class identification) in which the number of parameters of the neural networks has been suppressed. Furthermore, because the number of neural networks in the ensemble can be increased, the robustness can be improved.

### Fifth Example Embodiment

FIG. 11 is a schematic block diagram showing an example of a functional configuration of a learning device 500 according to a fifth example embodiment. In the configuration shown in FIG. 11, the learning device 500 includes a mask initialization unit 501, a loss function calculation unit 502, and a parameter updating unit 503.

In such a configuration, the mask initialization unit 501 determines, with respect to the parameters of machine learning models having a plurality of parameters, mask information representing a distinction between shared parameters provided for common use by a plurality of machine learning models, and non-shared parameters that are provided individually to each machine learning model. The loss function calculation unit 502 calculates, with respect to training data, a value of a loss function based on the shared parameters, the non-shared parameters, and the plurality of machine learning models to which the parameter values indicated by the mask information have been applied. The parameter updating unit 503 uses the value of the loss function to update values of the shared parameters and values of the non-shared parameters.

The mask initialization unit 501 corresponds to an example of a mask initialization means. The loss function calculation unit 502 corresponds to an example of a loss function calculation means. The parameter updating unit 503 corresponds to an example of a parameter updating means.

According to the learning device 500, the number of parameter values to be stored by a determination device that uses a plurality of machine learning models can be made relatively small.

For example, the learning device 500 is capable of suppressing the number of parameters of the neural networks in the ensemble in ensemble-based robust training (ERT). Therefore, because the learning device 500 is capable of suppressing the storage capacity of the memory or the like, it is possible to increase the number of neural networks in the ensemble. Therefore, the learning device 500 is capable of improving the robustness in ensemble-based robust training.

### Sixth Example Embodiment

FIG. 12 is a flowchart showing an example of the processing procedure performed in a learning method according to a sixth example embodiment. The learning method shown in FIG. 12 includes determining mask information (step S501), calculating a loss function (step S502), and updating shared parameters and non-shared parameters (step S503).

In determining mask information (step S501), a computer determines, with respect to the parameters of machine learning models having a plurality of parameters, mask information representing a distinction between shared parameters provided for common use by a plurality of machine learning models, and non-shared parameters that are provided individually to each machine learning model. In calculating a loss function (step S502), a computer calculates a loss function based on the plurality of machine learning models by using training data. In updating shared parameters and non-shared parameters (step S503), a computer uses the value of the loss function to update the shared parameters and the non-shared parameters by error backpropagation.

According to the learning method shown in FIG. 12, the number of parameter values to be stored by a determination device that uses a plurality of machine learning models can be made relatively small. For example, according to the learning method shown in FIG. 12, it is possible to suppress the number of parameters of the neural networks in the ensemble in ensemble-based robust training (ERT). Therefore, because the learning method is capable of suppressing the storage capacity of the memory or the like, it is possible to increase the number of neural networks in the ensemble. Therefore, the learning method is capable of improving the robustness in ensemble-based robust training.

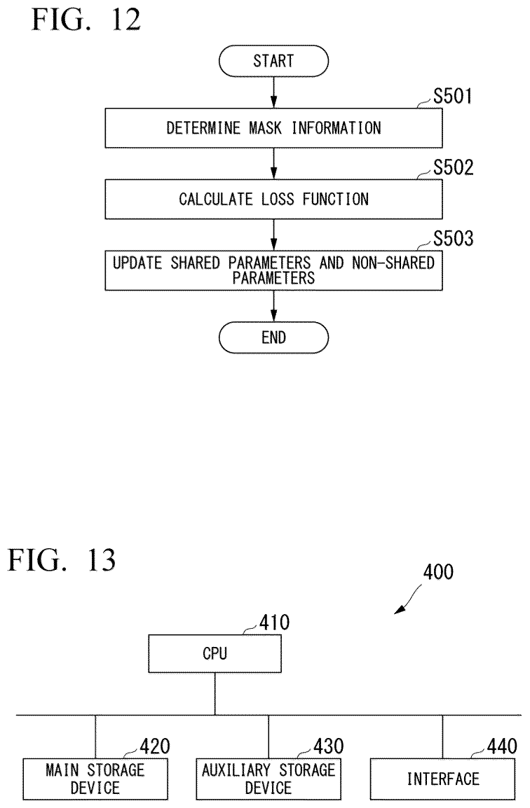

FIG. 13 is a schematic block diagram showing a configuration of a computer according to at least one example embodiment.

In the configuration shown in FIG. 13, a computer 400 includes a CPU (Central Processing Unit) 410, a main storage device 420, an auxiliary storage device 430, and an interface 440.

Any one or more of the learning devices 100 and 200 described above may be implemented by the computer 400. In this case, the operation of each of the processing units described above is stored in the auxiliary storage device 430 in the form of a program. The CPU 410 reads the program from the auxiliary storage device 430, expands the program in the main storage device 420, and executes the processing described above according to the program. Furthermore, the CPU 410 reserves a storage area corresponding to each of the storage units mentioned above in the main storage device 420 according to the program. The communication of each device with other devices is executed as a result of the interface 440 having a communication function and performing communication according to the control of the CPU 410.

If the learning device 100 is implemented by the computer 400, the operations of the mask initialization unit 111, the parameter initialization unit 112, the training data acquisition unit 113, and the learning unit 114, and the operations of the mini-batch sampling unit 115, the layer selection unit 116, the parameter determination unit 117, the loss function calculation unit 118, and the parameter updating unit 119 included in the learning unit 114 are stored in the auxiliary storage device 430 in the form of a program. The CPU 410 reads the program from the auxiliary storage device 430, expands the program in the main storage device 420, and executes the processing described above according to the program.

The output of the learning device 100 is executed as a result of the interface 440 having an output function such as a communication function or a display function, and performing output processing according to the control of the CPU 410.

If the learning device 200 is implemented by the computer 400, the operations of the mask initialization unit 211, the parameter initialization unit 212, the training data acquisition unit 213, the learning unit 214, and the mask determination unit 221, and the operations of the mini-batch sampling unit 215, the layer selection unit 216, the parameter determination unit 217, the loss function calculation unit 218, the mask updating unit 219, and the parameter updating unit 119 included in the learning unit 114 are stored in the auxiliary storage device 430 in the form of a program. The CPU 410 reads the program from the auxiliary storage device 430, expands the program in the main storage device 420, and executes the processing described above according to the program.

The output of the learning device 100 is executed as a result of the interface 440 having an output function such as a communication function or a display function, and performing output processing according to the control of the CPU 410.

The example embodiments of the present invention have been described in detail above with reference to the drawings. However, specific configurations are in no way limited to the example embodiments, and include design changes and the like within a scope not departing from the spirit of the present invention.

The whole or part of the example embodiments above can be described as the supplementary notes below, but the example embodiments are not limited thereto.

### (Supplementary Note 1)

A learning device comprising:
a mask initialization means that determines, for a plurality of parameters of a machine learning model having the plurality of parameters, mask information representing a distinction between a shared parameter provided for common use by a plurality of machine learning models, and a non-shared parameter that is provided individually to each machine learning model;
a loss function calculation means that calculates a value of a loss function with respect to training data, the loss function being based on the plurality of machine learning models to which the shared parameter, the non-shared parameter, and a parameter value indicated by the mask information have been applied; and
a parameter updating means that updates a value of the shared parameter and a value of the non-shared parameter by using the value of the loss function.

### (Supplementary Note 2)

The learning device according to supplementary note 1, further comprising
a parameter determination means that configures one machine learning model among the plurality of machine learning models by setting, to an element that is set as the shared parameter by the mask information among elements of a parameter vector of a model template, a value of a shared parameter from a shared parameter vector and by setting, to an element that is set as the non-shared parameter by the mask information among the elements of the parameter vector, a value of a non-shared parameter from a non-shared parameter vector, wherein the parameter vector is parameters of one of the machine learning models that are configured as a vector, the model temple includes the parameter vector and is provided for common use by the plurality of machine learning models, the shared parameter vector is the shared parameter configured as a vector and is provided for common use by the plurality of machine learning models, and the non-shared parameter vector is the non-shared parameter configured as a vector and is provided individually to each machine learning model.

### (Supplementary Note 3)

The learning device according to supplementary note 1 or 2, wherein the mask initialization means determines the mask information such that a shared parameter among parameters of one of the machine learning models is randomly selected.

### (Supplementary Note 4)

The learning device according to any one of supplementary notes 1 to 3,
wherein the mask information includes a continuous value for each parameter of one of the machine learning models, and
the learning device further comprises a mask updating means that update a value of each parameter in the mask information by using a value of the loss function.

### (Supplementary Note 5)

The learning device according to any one of supplementary notes 1 to 4, wherein calculation of the loss function by the loss function calculation means, and updating of the shared parameter and the non-shared parameter by the parameter updating means are repeated until a predetermined condition is met.

### (Supplementary Note 6)

The learning device according to any one of supplementary notes 1 to 5, wherein the loss function is a function that outputs a relatively small value in a case where input data, in which an adversarial perturbation has been added that causes one of the machine learning models to make an incorrect determination, does not cause the other machine learning models to make an incorrect determination.

### (Supplementary Note 7)

The learning device according to any one of supplementary notes 1 to 6, wherein the machine learning model is a neural network.

### (Supplementary Note 8)

A determination device comprising:
the plurality of machine learning models that have been trained by the learning device according to any one of supplementary notes 1 to 7; and
a majority vote means that takes a majority vote of outputs of the plurality of machine learning models.

### (Supplementary Note 9)

A learning method executed by a computer, comprising the steps of:
determining, for a plurality of parameters of a machine learning model having the plurality of parameters, mask information representing a distinction between a shared parameter provided for common use by a plurality of machine learning models, and a non-shared parameter that is provided individually to each machine learning model;
calculating a value of a loss function with respect to training data, the loss function being based on the plurality of machine learning models to which the shared parameter, the non-shared parameter, and a parameter value indicated by the mask information have been applied; and
updating a value of the shared parameter and a value of the non-shared parameter by using the value of the loss function.

### (Supplementary Note 10)

A recording medium that records a program that causes a computer to execute the steps of:
determining, for a plurality of parameters of a machine learning model having the plurality of parameters, mask information representing a distinction between a shared parameter provided for common use by a plurality of machine learning models, and a non-shared parameter that is provided individually to each machine learning model;
calculating a value of a loss function with respect to training data, the loss function being based on the plurality of machine learning models to which the shared parameter, the non-shared parameter, and a parameter value indicated by the mask information have been applied; and
updating a value of the shared parameter and a value of the non-shared parameter by using the value of the loss function.

### INDUSTRIAL APPLICABILITY

The example embodiments of the present invention may be applied to a learning device, a determination device, a learning method, and a recording medium.

### DESCRIPTION OF REFERENCE SYMBOLS

100, 200 Learning device
110, 210 Control unit
111, 211 Mask initialization unit
112, 212 Parameter initialization unit
113, 213 Training data acquisition unit
114, 214 Learning unit
115, 215 Mini-batch sampling unit
116, 216 Layer selection unit
117, 217 Parameter determination unit
118, 218 Loss function calculation unit
219 Mask updating unit
119, 220 Parameter updating unit
221 Mask determination unit
130, 230 Storage unit
131, 231 Training data storage unit
300 Determination device
301 Neural network
302 Majority vote unit

What is claimed is:

1. A learning device comprising:
a memory configured to store instructions; and
a processor configured to execute the instructions to:
determine, for a plurality of parameters of a machine learning model having the plurality of parameters, mask information representing a distinction between a shared parameter provided for common use by a plurality of machine learning models that includes the machine learning model, and a non-shared parameter that is provided individually to each machine learning model;
calculate a value of a loss function with respect to training data, the loss function being based on the plurality of machine learning models to which the shared parameter, the non-shared parameter, and a parameter value indicated by the mask information have been applied; and
update a value of the shared parameter and a value of the non-shared parameter by using the value of the loss function.

2. The learning device according to claim 1, wherein the processor is configured to execute the instructions to configure one machine learning model among the plurality of machine learning models by setting, to an element that is set as the shared parameter by the mask information among elements of a parameter vector of a model template, a value of a shared parameter from a shared parameter vector and by setting, to an element that is set as the non-shared parameter by the mask information among the elements of the parameter vector, a value of a non-shared parameter from a non-shared parameter vector, and wherein the parameter vector is parameters of one of the machine learning models that are configured as a vector, the model temple includes the parameter vector and is provided for common use by the plurality of machine learning models, the shared parameter vector is the shared parameter configured as a vector and is provided for common use by the plurality of machine learning models, and the non-shared parameter vector is the non-shared parameter configured as a vector and is provided individually to each machine learning model.

3. The learning device according to claim 1, wherein the processor is configured to execute the instructions to determine the mask information such that a shared parameter among parameters of one of the machine learning models is randomly selected.

4. The learning device according to claim 1,
wherein the mask information includes a continuous value for each parameter of one of the machine learning models, and
the processor is configured to execute the instructions to update a value of each parameter in the mask information by using a value of the loss function.

5. The learning device according to claim 1, wherein calculation of the loss function, and updating of the shared parameter and the non-shared parameter are repeated until a predetermined condition is met.

6. The learning device according to claim 1, wherein the loss function is a function that outputs a relatively small value in a case where input data, in which an adversarial perturbation has been added that causes one of the machine learning models to make an incorrect determination, does not cause the other machine learning models to make an incorrect determination.

7. The learning device according to claim 1, wherein the machine learning model is a neural network.

8. A determination device comprising:
the plurality of machine learning models that have been trained by the learning device according to claim 1;
a memory configured to store instructions; and
a processor configured to execute the instructions to:
take a majority vote of outputs of the plurality of machine learning models.

9. A learning method executed by a computer, comprising:
determining, for a plurality of parameters of a machine learning model having the plurality of parameters, mask information representing a distinction between a shared parameter provided for common use by a plurality of machine learning models that includes the machine learning model, and a non-shared parameter that is provided individually to each machine learning model;
calculating a value of a loss function with respect to training data, the loss function being based on the plurality of machine learning models to which the shared parameter, the non-shared parameter, and a parameter value indicated by the mask information have been applied; and
updating a value of the shared parameter and a value of the non-shared parameter by using the value of the loss function.

10. (canceled)
